(19) United States
(12) Patent Application Publication
(10) Pub. No.: US 2014/0308562 A1
(43) Pub. Date: Oct. 16, 2014

(54) ELECTROLYTE FOR LITHIUM SECONDARY BATTERY AND LITHIUM SECONDARY BATTERY INCLUDING THE SAME

(71) Applicant: Samsung SDI Co., Ltd., Yongin-si (KR)

(72) Inventors: Myung-Hwan Jeong, Yongin-si (KR); Soo-Jin Kim, Yongin-si (KR); Myung-Heui Woo, Yongin-si (KR); Hye-Jin Park, Yongin-si (KR); Moon-Sung Kim, Yongin-si (KR); Si-Young Cha, Yongin-si (KR); Min-Ju Lee, Yongin-si (KR); Vladimir Egorov, Yongin-si (KR); Woo-Cheol Shin, Yongin-si (KR)

(73) Assignee: Samsung SDI Co., Ltd., Yongin-si (KR)

(21) Appl. No.: 14/155,282

(22) Filed: Jan. 14, 2014

Related U.S. Application Data
(60) Provisional application No. 61/812,638, filed on Apr. 16, 2013.

(51) Int. Cl. H01M 10/0567; H01M 10/0569; H01M 10/42; H01M 10/0568

(52) U.S. Cl. CPC H01M 10/0567; H01M 10/0568; H01M 10/0569; H01M 10/4235
USPC 429/126; 558/201; 429/188; 429/199; 429/332

(57) ABSTRACT

An electrolyte for lithium secondary batteries includes a lithium salt, a nonaqueous organic solvent, and a compound represented by Formula 1 below as an additive:

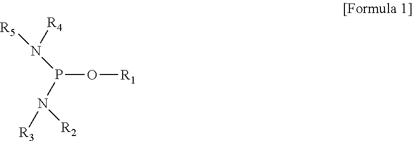

where R₁, R₂, R₃, R₄, and R₅ in Formula 1 are defined as those specified in the specification.

### CROSS-REFERENCE TO RELATED APPLICATION

This application claims priority to and the benefit of U.S. Provisional Application No. 61/812,638, filed on Apr. 16, 2013 in the U.S. Patent and Trademark Office, the entire content of which is incorporated herein by reference.

### BACKGROUND

1. Field

One or more embodiments of the present invention relate to an electrolyte for a lithium secondary battery, and a lithium secondary battery including the electrolyte. The electrolyte for the lithium secondary battery may improve high-rate characteristics, high-temperature storage characteristics, and/or lifetime characteristics of the lithium secondary battery.

2. Description of the Related Art

Lithium secondary batteries are rechargeable at high rates and have energy densities per unit weight that are about three times higher than lead storage batteries, nickel-cadmium (Ni—Cd) batteries, nickel-hydrogen batteries, and nickel-zinc batteries, and thus there has been increasing research and development into lithium secondary batteries.

In general, a lithium secondary battery includes a positive electrode, a negative electrode, a separator disposed between the positive electrode and the negative electrode, and an electrolyte. The electrolyte serves to transfer lithium ions between the positive electrode and the negative electrode.

Lithium ions may maintain charge neutrality at the electrodes of a lithium secondary battery with electrons from one of the electrodes, and thus may serve as media for storing electric energy in the electrodes. Accordingly, the amount of lithium ions intercalated into the electrode is important. Thus, to achieve high battery performance, an electrolyte with high ionic conductivity, high electrochemical stability and high thermal stability is desired.

Recently, with an increasing demand for lithium secondary batteries with high energy densities, for example, for use in electric vehicles, electrode active materials for use at high-voltages have become available. Using a low-potential negative active material and a high-potential positive active material makes a potential window of the electrolyte more narrow than potential windows of the negative and positive active materials, and thus the electrolyte may become more vulnerable to decompose at the surface of the positive or negative electrode. Lithium secondary batteries for electric vehicles and power storage devices are likely to be exposed to high-temperature external environments and spontaneous internal temperature rises due to instantaneous charging and discharging, and thus may have shortened lifetimes in such high-temperature environments and a reduction in stored energy.

Therefore, there has been a demand for the development of an electrolyte composition for lithium secondary batteries suitable for use in high-temperature environments.

### SUMMARY

One or more embodiments of the present invention are directed toward an electrolyte for lithium secondary batteries that facilitates the transfer of lithium ions and forms a thin film on a surface region of a positive electrode and/or a negative electrode to prevent or reduce direct contact therewith.

One or more embodiments of the present invention are directed toward a lithium secondary battery with improved high-rate characteristics, improved high-temperature storage characteristics, and/or improved lifetime characteristics.

In an embodiment, a phosphorus compound is provided, represented by the following Formula 1:

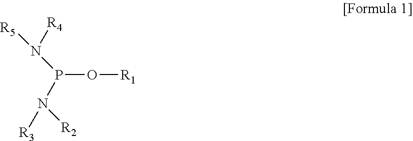

wherein R₁ to R₅ are each independently selected from a hydrogen atom, a halogen atom, a hydroxy group, a cyano group, —OR (where R is a C1-C10 alkyl group or a C6-C20 aryl group), —C(═O)Rₐ, —C(═O)ORₐ, —OCO(ORₐ), —(X)ₙ—NH₂ (where X is a C1-C10 alkyl group or a C1-C10 alkoxy group, and n is an integer from 0 to 10), —(X₁)ₙ—C(Rₐ)₃ (where X₁ is a C1-C10 alkyl group or a C1-C10 alkoxy group, and n is an integer from 0 to 10), —(X₂)ₙ—CH═CH₂ (where X₂ is a C1-C10 alkyl group or a C1-C10 alkoxy group, and n is an integer from 1 to 10), —C═N(Rₐ), —SRₐ, —S(═O)Rₐ, —S(═O)₂Rₐ, a substituted or unsubstituted C1-C20 alkyl group, a substituted or unsubstituted C1-C20 alkoxy group, a substituted or unsubstituted C2-C20 alkenyl group, a substituted or unsubstituted C2-C20 alkynyl group, a C2-C20 alkylene oxide group, a substituted or unsubstituted C3-C30 cycloalkyl group, a substituted or unsubstituted C6-C30 aryl group, a substituted or unsubstituted C6-C30 aryloxy group, and a substituted or unsubstituted C6-C30 heteroaryl group, where Rₐ is selected from a hydrogen atom, a halogen atom, a C1-C10 alkyl group, and a C6-C20 aryl group.

In one embodiment, R₁ is selected from a halogen atom, —(X₁)ₙ—C(Rₐ)₃ (where X₁ is a C1-C10 alkyl group or a C1-C10 alkoxy group, and n is an integer from 1 to 10), and a substituted or unsubstituted C1-C20 alkyl group, where Rₐ is selected from a hydrogen atom, a halogen atom, a C1-C10 alkyl group and a C6-C20 aryl group.

In one embodiment, R₁ is selected from —F, —Cl, —Br, —I, —(CH₂)—CF₃, —(CH₂)—CCl₃, —(CH₂)—CBr₃, —(CH₂)—CCl₃, —(CH₂)₂—CF₃, —(CH₂)₂—CCl₃, —(CH₂)₂—CBr₃, —(CH₂)₃—CF₃, —(CH₂)₃—CCl₃, —(CH₂)₃—CBr₃, —(CH₂)₄—CF₃, —(CH₂)₄—CCl₃, —(CH₂)₄—CBr₃, —(CH₂)₅—CF₃, —(CH₂)₅—CCl₃, —(CH₂)₅—CBr₃, —(CF₂)—CF₃, —(CF₂)₂—CF₃, —(CF₂)₃—CF₃, —(CF₂)₄—CF₃, —(CF₂)₅—CF₃, —(CF₂)—CCl₃, —(CF₂)₂—CCl₃, —(CF₂)₃—CCl₃, —(CF₂)₄—CCl₃, —(CF₂)₅—CCl₃, —(CCl₂)—CF₃, —(CCl₂)₂—CF₃, —(CCl₂)₃—CF₃, —(CCl₂)₄—CF₃, —(CCl₂)₅—CF₃, —(CCl₂)—CCl₃, —(CCl₂)₂—CCl₃, —(CCl₂)₃—CCl₃, —(CCl₂)₄—CCl₃, and —(CCl₂)₅—CCl₃.

In one embodiment, R₁ is selected from —F, —(CH₂)—CF₃, —(CH₂)₂—CF₃, —(CH₂)₃—CF₃, —(CH₂)₄—CF₃, —(CH₂)₅—CF₃, —(CF₂)—CF₃, —(CF₂)₂—CF₃, —(CF₂)₃—CF₃, —(CF₂)₄—CF₃, and —(CF₂)₅—CF₃.

In one embodiment, R₂ to R₅ are each independently selected from —(X₂)ₙ—CH═CH₂, (wherein X₂ is a C1-C10 alkyl group or a C1-C10 alkoxy group, and n is an integer from 1 to 10), —C═N(Rₐ), —S(═O)Rₐ, —S(═O)₂Rₐ, a substituted or unsubstituted C2-C20 alkenyl group, a substituted or unsubstituted C2-C20 alkynyl group, a C2-C20 alkylene oxide group, a substituted or unsubstituted C6-C30 aryl group, a substituted or unsubstituted C6-C30 aryloxy group, and a substituted or unsubstituted C6-C30 heteroaryl group, where Rₐ is selected from a hydrogen atom, a halogen atom, a C1-C10 alkyl group, and a C6-C20 aryl group.

In one embodiment, R₂, to R₅ are each independently selected from a substituted or unsubstituted C2-C20 alkenyl group; and —(X₂)ₙ—CH═CH₂, wherein X₂ is a C1-C10 alkyl group or a C1-C10 alkoxy group, and n is an integer from 1 to 10).

In one embodiment, R₂ to R₅ are each independently selected from —CH═CH₂, —(CH₂)—CH═CH₂, —(CH₂)₂—CH═CH₂, —(CH₂)₃—CH═CH₂, —(CH₂)₄—CH═CH₂, —(CH₂)₅—CH═CH₂, —(C₂H₄)₃—CH═CH₂, —(C₂H₄)₄—CH═CH₂, —(C₂H₄)₅—CH═CH₂, —(C₃H₆)₃—CH═CH₂, —(C₃H₅)₄—CH═CH₂, —(C₃H₆)₅—CH═CH₂, —(CH₂O)—CH═CH₂, —(CH₂O)₂—CH═CH₂, —(CH₂O)₃—CH═CH₂, —(CH₂O)₄—CH═CH₂, —(CH₂O)₅—CH═CH₂, —(C₂H₄O)—CH═CH₂, —(C₂H₄O)₂—CH═CH₂, —(C₂H₄O)₃—CH═CH₂, —(C₂H₄O)₄—CH═CH₂, —(C₂H₄O)₅—CH═CH₂, —(C₃H₆O)—CH═CH₂, —(C₃H₆O)₂—CH═CH₂, —(C₃H₆O)₃—CH═CH₂, —(C₃H₆O)₄—CH═CH₂, —(C₃H₆O)₆—CH═CH₂, —(C₄H₈O)—CH═CH₂, —(C₄H₈O)₂—CH═CH₂, —(C₄H₈O)₃—CH═CH₂, —(C₄H₈O)₄—CH═CH₂, —(C₄H₈O)₅—CH═CH₂, —(C₅H₁₀O)—CH═CH₂, —(C₅H₁₀O)₂—CH═CH₂, —(C₅H₁₀O)₃—CH═CH₂, —(C₅H₁₀O)₄—CH═CH₂, —(C₅H₁₀O)₅—CH═CH₂, and a substituted C2-C20 alkenyl group.

In one embodiment, the phosphorus compound is represented by one of the following Formulas 2 to 6:

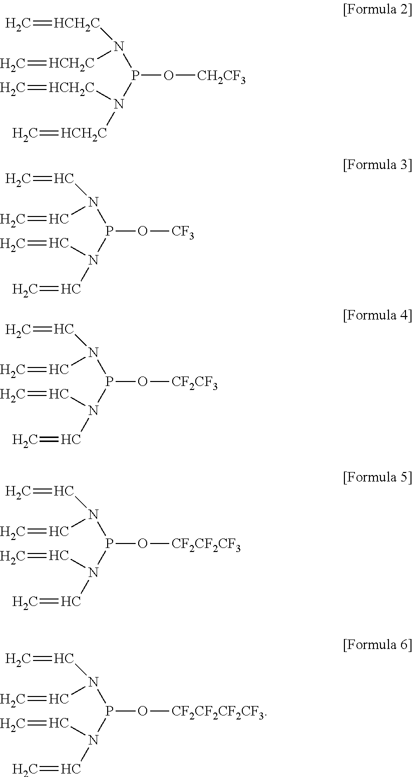

In another embodiment, an electrolyte for a lithium secondary battery is provided. The electrolyte includes the phosphorus compound according Formula 1.

In one embodiment, the phosphorus compound is present in an amount of about 0.3 wt % to about 13 wt % based on a total weight of the electrolyte.

In one embodiment, the phosphorus compound is present in an amount of about 0.5 wt % to about 10 wt % based on a total weight of the electrolyte.

In one embodiment, the electrolyte further includes a lithium salt and a non-aqueous organic solvent.

In one embodiment, the lithium salt is selected from LiPF₆, LIBF₄, LiSbF₆, LiAsF₆, LiCF₃SO₃, Li(CF₃SO₂)₃C, Li(CF₃SO₂)₂N, LiC₄F₉SO₃, LiClO₄, LiAlO₄, LiAlCl₄, LiBPh₄, LiN(CₓF₂ₓ₊₁SO₂)(CₓF_{2y+1}SO₂) (where x and y are non-zero natural numbers), LiCl, Lil, LIBOB (lithium bisoxalato borate), and combinations thereof.

In one embodiment, the nonaqueous organic solvent is selected from a carbonate-based solvent, an ester-based solvent, an ether-based solvent, a ketone-based solvent, an alcohol-based solvent, an aprotic solvent, and combinations thereof.

In a further embodiment, a method of preparing the phosphorus compound according to Formula 1 is provided. The method includes reacting a compound represented by the following Formula 12:

R₁—O—PX′₂ [Formula 12]

with a compound represented by the following Formula 13 or Formula 14:

R₂R₃NH [Chemical Formula 13]

R₄R₅NH, [Chemical Formula 14]
wherein X′ is selected from chlorine, bromine and iodine.

In a further embodiment, a lithium secondary battery is provided. The lithium secondary battery includes an electrolyte, the electrolyte including an additive, the additive being a phosphorus compound represented by the following Formula 1:

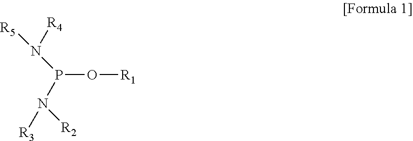

wherein R₁ to R₅ are each independently selected from a hydrogen atom, a halogen atom, a hydroxy group, a cyano group, —OR (where R is a C1-C10 alkyl group or a C6-C20 aryl group), —C(═O)Rₐ, —C(═O)ORₐ, —OCO(ORₐ), —(X)ₙ—NH₂ (where X is a C1-C10 alkyl group or a C1-C10 alkoxy group, and n is an integer from 0 to 10), —(X₁)ₙ—C(Rₐ)₃ (where X₁ is a C1-C10 alkyl group or a C1-C10 alkoxy group, and n is an integer from 0 to 10), —(X₂)ₙ—CH═CH₂ (where X₂ is a C1-C10 alkyl group or a C1-C10 alkoxy group, and n is an integer from 1 to 10), —C═N(Rₐ), —SRₐ, —S(═O)Rₐ, —S(═O)₂Rₐ, a substituted or unsubstituted C1-C20 alkyl group, a substituted or unsubstituted C1-C20 alkoxy group, a substituted or unsubstituted C2-C20 alkenyl group, a substituted or unsubstituted C2-C20 alkynyl group, a C2-C20 alkylene oxide group, a substituted or unsubstituted C3-C30 cycloalkyl group, a substituted or unsubstituted C6-C30 aryl group, a substituted or unsubstituted C6-C30 aryloxy group, and a substituted or unsubstituted C6-C30 heteroaryl group, where Rₐ is selected from a hydrogen atom, a halogen atom, a C1-C10 alkyl group, and a C6-C20 aryl group.

In one embodiment, the lithium secondary battery includes a positive electrode including a positive active material configured to allow intercalation and deintercalation of lithium ions; a negative electrode including a negative active material configured to allow intercalation and deintercalation of lithium ions; and the electrolyte between the positive electrode and the negative electrode, the electrolyte including a lithium salt, and a nonaqueous organic solvent.

In one embodiment, the lithium secondary battery further includes a thin film on a surface of the positive electrode, the thin film including the additive.

In one embodiment, the lithium secondary battery further includes a solid electrolyte interface (SEI) layer on a surface of the negative electrode, the solid electrolyte interface (SEI) layer including a reaction product of the additive.

In one embodiment, the positive active material has an operation voltage of about 4.0V to about 5.5V.

Embodiments of the present invention are directed toward an electrolyte for lithium secondary batteries including a compound of Formula 1 above as an additive. Embodiments of the present invention are also directed toward a lithium secondary battery including this electrolyte, which may include a thin film derived from the additive on a surface of a positive electrode and/or a negative electrode to block direct contact of the positive electrode and/or negative electrode with the electrolyte during operation of the lithium secondary battery, and thus to prevent oxidation and decomposition of the electrolyte. Accordingly, embodiments of the present invention are directed toward a lithium secondary battery having improved high-rate characteristics, high-temperature storage characteristics, and/or lifetime characteristics.

### BRIEF DESCRIPTION OF THE DRAWINGS

The accompanying drawings, together with the specification, illustrate embodiments of the present invention, and, together with the description, serve to explain the principles of the present invention.

FIG. 1 is a schematic cross-sectional view illustrating thin films formed on a surface of a positive electrode and a negative electrode of a lithium secondary battery, according to an embodiment of the present invention;

FIG. 2 is an exploded perspective view of a lithium secondary battery according to an embodiment of the present invention;

FIG. 3A is a scanning electron microscopic (SEM) image of the surface of the positive electrode of the lithium secondary battery of Example 10 at about 45° C. after 100 times of charging and discharging;

FIG. 3B is a SEM image of the surface of the negative electrode of the lithium secondary battery of Example 10 at about 45° C. after 100 times of charging and discharging;

FIG. 4A is a graph of X-ray photoelectron spectrum data for the material on the surface of the negative electrode of the lithium secondary battery of Example 10 after 100 times of charging and discharging;

FIG. 4B is a graph of X-ray photoelectron spectrum data for the material on the surface of the negative electrode of the lithium secondary battery of Comparative Example 6 after 100 times of charging and discharging;

FIG. 5 is a graph of capacity with respect to rate in each of the lithium secondary batteries of Examples 10 to 16 and Comparative Examples 6 to 10;

FIG. 6 is a graph of capacity retention rates of each of the lithium secondary batteries of Examples 10, 11, and 13 to 18, and Comparative Examples 6 to 10 after high-temperature storage at about 60° C.; and

FIG. 7 is a graph of capacity retention rates at about 45° C. of each of the lithium secondary batteries of Examples 10 to 18 and Comparative Examples 6 to 10.

### DETAILED DESCRIPTION

In the following detailed description, only certain embodiments of the present invention are shown and described, by way of illustration. As those skilled in the art would recognize, the invention may be embodied in many different forms and should not be construed as being limited to the embodiments set forth herein. Also, in the context of the present application, when a first element is referred to as being “on” a second element, it can be directly on the second element or be indirectly on the second element with one or more intervening elements interposed therebetween. Further, the use of “may” when describing embodiments of the present invention refers to “one or more embodiments of the present invention.” Like reference numerals designate like elements throughout the specification.

Hereinafter, embodiments of an electrolyte for lithium secondary batteries, and a lithium secondary battery including the electrolyte will be described in more detail.

According to an embodiment of the present invention, an electrolyte for lithium secondary batteries includes a lithium salt, a nonaqueous organic solvent, and a phosphorous compound represented by Formula 1 below as an additive:

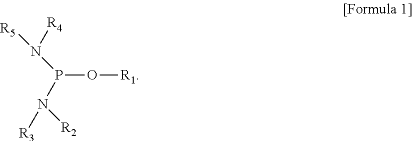

In Formula 1, R₁, R₂, R₃, R₄, and R₅ are each independently selected from a hydrogen atom, a halogen atom, a hydroxy group, a cyano group, —OR (where R is a C1-C10 alkyl group or a C6-C20 aryl group), —C(═O)Rₐ, —C(═O)ORₐ, —OCO(ORₐ), —(X)ₙ—NH₂(where X is a C1-C10 alkyl group or a C1-C10 alkoxy group, and n is an integer from 0 to 10), —(X₁)ₙ—C(Rₐ)₃ (where X₁ is a C1-C10 alkyl group or a C1-C10 alkoxy group, and n is an integer from 0 to 10), —(X₂)ₙ—CH═CH₂ (X₂ is a C1-C10 alkyl group or a C1-C10 alkoxy group, and n is an integer from 1 to 10), —C═N(Rₐ), —SRₐ, —S(═O)Rₐ, —S(═O)₂Rₐ, a substituted or unsubstituted C1-C20 alkyl group, a substituted or unsubstituted C1-C20 alkoxy group, a substituted or unsubstituted C2-C20 alkenyl group, a substituted or unsubstituted C2-C20 alkynyl group, a C2-C20 alkylene oxide group, a substituted or unsubstituted C3-C30 cycloalkyl group, a substituted or unsubstituted C6-C30 aryl group, a substituted or unsubstituted C6-C30 aryloxy group, and a substituted or unsubstituted C6-C30 heteroaryl group, where Rₐ is selected from a hydrogen atom, a halogen atom, a C1-C10 alkyl group, and a C6-C20 aryl group.

The additive has a structure with two nitrogen (N) atoms and one oxygen (O) atom bound to a phosphorous (III) atom center. In particular, in the phosphorous compound of Formula 1 used as an additive, one nitrogen atom and one oxygen atom are bound to the phosphorous (III) atom center with an electronegativity of about 0.8 and 1.3, respectively, so that electrons are slightly attracted towards the oxygen atom.

In Formula 1 of the phosphorous compound as an additive, R₁ may be selected from a halogen atom, —(X₁)ₙ—C(R₂)₃(where X₁ is a C1-C10 alkyl group or a C1-C10 alkoxy group, and n is an integer of 1 to 10), and a substituted or unsubstituted C1-C20 alkyl group, where Rₐ may be selected from a hydrogen atom, a halogen atom, a C1-C10 alkyl group or a C6-C20 aryl group. In other words, a halogen atom, —(X₁)ₙ—C(Rₐ)₃, or a substituted or unsubstituted C1-C20 alkyl group may be bound to the oxygen atom in a P—O bond of the additive.

In some embodiments, R₁ of the additive in Formula 1 is selected from —F, —Cl, —Br, —I, —(CH₂)—CH₃, —(CH₂)—CF₃, —(CH₂)—CCl₃, —(CH₂)—CBr₃, —(CH₂)—C(CH₃)₃, —(CH₂)—C₂H₅, —(CH₂)—C₆H₅, —(CH₂)₂—CH₃, —(CH₂)₂—CF₃, —(CH₂)₂—CCl₃, —(CH₂)₂—CBr₃, —(CH₂)₂—C(CH₃)₃, —(CH₂)₂—C₂H₅, —(CH₂)₂—C₆H₅, —(CH₂)₃—CH₃, —(CH₂)₃—CF₃, —(CH₂)₃—CCl₃, —(CH₂)₃—CBr₃, —(CH₂)₃—C(CH₃)₃, —(CH₂)₃—C₂H₅, —(CH₂)₃—C₆H₅, —(CH₂)₄—CH₃, —(CH₂)₄—CF₃, —(CH₂)₄—CCl₃, —(CH₂)₄—CBr₃, —(CH₂)₄—C(CH₃)₃, —(CH₂)₄—C₂H₅, —(CH₂)₄—C₆H₅, —(CH₂)₅—CH₃, —(CH₂)₅—CF₃, —(CH₂)₅—CCl₃, —(CH₂)₅—CBr₃, —(CH₂)₅—C(CH₃)₃, —(CH₂)₅—C₂H₅, —(CH₂)₅—C₆H₅, —(CF₂)—CF₃, —(CF₂)₂—CF₃, —(CF₂)₃—CF₃, —(CF₂)₄—CF₃, —(CF₂)₅—CF₃, —(CF₂)—CCl₃, —(CF₂)₂—CCl₃, —(CF₂)₃—CCl₃, —(CF₂)₄—CCl₃, —(CF₂)₅—CCl₃, —(CCl₂)—CF₃, —(CCl₂)₂—CF₃, —(CCl₂)₃—CF₃, —(CCl₂)₄—CF₃, —(CCl₂)₅—CF₃, —(CCl₂)—CCl₃, —(CCl₂)₂—CCl₃, —(CCl₂)₃—CCl₃, —(CCl₂)₄—CCl₃, and —(CCl₂)₅—CCl₃.

In some other embodiments, R₁ of the additive in Formula 1 is selected from —F, —Cl, —Br, —I, —(CH₂)—CF₃, —(CH₂)—CCl₃, —(CH₂)—CBr₃, —(CH₂)—CCl₃, —(CH₂)₂—CF₃, —(CH₂)₂—CCl₃, —(CH₂)₂—CBr₃, —(CH₂)₃—CCl₃, —(CH₂)₃—CCl₃, —(CH₂)₃—CBr₃, —(CH₂)₄—CF₃, —(CH₂)₄—CCl₃, —(CH₂)₄—CBr₃, —(CH₂)₅—CF₃, —(CH₂)₅—CCl₃, —(CH₂)₅—CCl₃, —(CF₂)—CF₃, —(CF₂)₂—CF₃, —(CF₂)₃—CF₃, —(CF₂)₄—CF₃, —(CF₂)₅—CF₃, —(CF₂)—CCl₃, —(CF₂)₂—CCl₃, —(CF₂)₃—CCl₃, —(CF₂)₄—CCl₃, —(CF₂)₅—CCl₃, —(CCl₂)—CF₃, —(CCl₂)₂—CF₃, —(CCl₂)₃—CF₃, —(CCl₂)₄—CF₃, —(CCl₂)₅—CF₃, —(CCl₂)—CCl₃, —(CCl₂)₂—CCl₃, —(CCl₂)₃—CCl₃, —(CCl₂)₄—CCl₃, and —(CCl₂)₅—CCl₃.

In some embodiments, R₁ of the additive in Formula 1 is selected from —F, —(CH₂)—CF₃, —(CH₂)₂—CF₃, —(CH₂)₃—CF₃, —(CH₂)₄—CF₃, —(CH₂)₅—CF₃, —(CF₂)—CF₃, —(CF₂)₂—CF₃, —(CF₂)₃—CF₃, —(CF₂)₄—CF₃, and —(CF₂)₅—CF₃.

When the compound of Formula 1 having these substituents as R₁ is used as an additive in an electrolyte, a lithium secondary battery including the additive in the electrolyte may have improved resistance to oxidation and chemicals, and thus may have improved lifetime characteristics at high voltages.

R₂, R₃, R₄, and R₅ in the additive of Formula 1 may be identical to each other or one or more of R₂, R₃, R₄, and R₅ may be different from each other.

In the additive of Formula 1, R₂, R₃, R₄, and R₅ may be each independently selected from —(X₂)ₙ—CH═CH₂, (X₂ is a C1-C10 alkyl group or a C1-C10 alkoxy group, and n is an integer from 1 to 10), —C═N(Rₐ), —S(═O)Rₐ, —S(═O)₂Rₐ, a substituted or unsubstituted C2-C20 alkenyl group, a substituted or unsubstituted C2-C20 alkynyl group, a C2-C20 alkylene oxide group, a substituted or unsubstituted C6-C30 aryl group, a substituted or unsubstituted C6-C30 aryloxy group, and a substituted or unsubstituted C6-C30 heteroaryl group, where Rₐ may be selected from a hydrogen atom, a halogen atom, a C1-C10 alkyl group, and a C6-C20 aryl group.

In some embodiments, R₂, R₃, R₄, and R₅ in the additive of Formula 1 may be each independently selected from —(X₂)ₙ—CH═CH₂ (where X₂ is a C1-C10 alkyl group or a C1-C10 alkoxy group, and n is an integer from 1 to 10), and a substituted or unsubstituted C2-C20 alkenyl group.

In some other embodiments, R₂, R₃, R₄, and R₅ in the additive of Formula 1 may be each independently selected from —CH═CH₂, —(CH₂)—CH═CH₂, —(CH₂)₂—CH═CH₂, —(CH₂)₃—CH═CH₂, —(CH₂)₄—CH═CH₂, —(CH₂)₅—CH═CH₂, —(C₂H₄)₃—CH═CH₂, —(C₂H₄)₄—CH═CH₂, —(C₂H₄)₅—CH═CH₂, —(C₃H₆)₃—CH═CH₂, —(C₃H₆)₄—CH═CH₂, —(C₃H₆)₅—CH═CH₂, —(CH₂O)—CH═CH₂, —(CH₂O)₂—CH═CH₂, —(CH₂O)₃—CH═CH₂, —(CH₂O)₄—CH═CH₂, —(CH₂O)₅—CH═CH₂, —(C₂H₄O)—CH═CH₂, —(C₂H₄O)₂—CH═CH₂, —(C₂H₄O)₃—CH═CH₂, —(C₂H₄O)₄—CH═CH₂, —(C₂H₄O)₅—CH═CH₂, —(C₃H₆O)—CH═CH₂, —(C₃H₆O)₂—CH═CH₂, —(C₃H₆O)₃—CH═CH₂, —(C₃H₆O)₄—CH═CH₂, —(C₃H₆O)₅—CH═CH₂, —(C₄H₈O)—CH═CH₂, —(C₄H₈O)₂—CH═CH₂, —(C₄H₈O)₃—CH═CH₂, —(C₄H₈O)₄—CH═CH₂, —(C₄H₈O)₅—CH═CH₂, —(C₅H₁₀O)—CH═CH₂, —(C₅H₁₀O)₂—CH═CH₂, —(C₅H₁₀O)₃—CH═CH₂, —(C₅H₁₀O)₄—CH═CH₂, —(C₅H₁₀O)₅—CH═CH₂, and a substituted C2-C20 alkenyl group. For example, a group with a double bond, like an alkenyl group, may be bound to the nitrogen (N) atom of a P—N bond of the additive of Formula 1.

In Formula 1, in embodiments where at least one of R₂, R₃, R₄, and R₅, have a double bond, the double bond may form a single bond by receiving electrons from anions dissociated in a nonaqueous organic solvent of the electrolyte by the melting of a lithium salt in the electrolyte during charging and discharging of a lithium secondary battery, and thus form a solid electrolyte interphase (SEI) layer on a surface of the negative electrode.

Substituents in Formula 1 above may be defined as follows. The term “substituted” used herein with reference to an alkyl group, an alkoxy group, an alkenyl group, an alkynyl group, an alkylene oxide group, a cycloalkyl group, an aryl group, an aryloxy group, and a heteroaryl group in Formula 1, refers to substitution of at least one hydrogen atom on these groups with, for example, one or more selected from a halogen atom, a C1-C20 alkyl group substituted with a halogen atom (for example, —CH₂CF₃, —CHCF₂, —CH₂F, —CCl₃, and the like), a hydroxy group, a nitro group, a cyano group, an amino group, an amidino group, a hydrazine, a hydrazone, a carboxyl group or a salt thereof, a sulfonic acid group or a salt thereof, a phosphoric acid group or a salt thereof, a C1-C20 alkyl group, a C2-C20 alkenyl group, a C2-C20 alkynyl group, a C1-C20 heteroalkyl group, a C6-C20 aryl group, a C6-C20 arylalkyl group, a C6-C20 heteroaryl group, and a C6-C20 heteroarylalkyl group.

Examples of the C1-C20 alkyl group in Formula 1 include methyl, ethyl, propyl, isobutyl, sec-butyl, tert-butyl, neo-butyl, iso-amyl, and hexyl. At least one hydrogen atom in these alkyl groups may be substituted with those substituents already described above in connection with the term “substituted”.

Examples of the C1-C20 alkoxy group in Formula 1 include methoxy, ethoxy, and propoxy. At least one hydrogen atom in these alkoxy groups may be substituted with those substituents already described above in connection with the term “substituted”.

Examples of the C2-C20 alkenyl group in Formula 1 include vinylene, allylene, and the like. At least one hydrogen atom in these alkenyl groups may be substituted with those substituents already described above in connection with the term “substituted”.

An example of the C2-C20 alkynyl group in Formula 1 includes acetylene. A hydrogen atom in the alkynyl group may be substituted with those substituents already described above in connection with the term “substituted”.

Examples of the C2-20 alkylene oxide group in Formula 1 include ethylene oxide, propylene oxide, butylene oxide, and hexylene oxide.

Examples of the C3-C30 cycloalkyl group in Formula 1 include cyclopropyl, cyclobutyl, cyclopentyl, and cyclohexyl. At least one hydrogen atom in these cycloalkyl groups may be substituted with those substituents already described above in connection with the term “substituted”.

The C6-30 aryl group in Formula 1 may be used alone or in combination, and refers to an aromatic system including at least one ring. Examples of the aryl group include phenyl, naphthyl, and tetrahydronaphthyl. At least one hydrogen atom in the aryl group may be substituted with those substituents already described above in connection with the term “substituted”.

An example of the C6-C30 aryloxy group in Formula 1 includes a phenoxy group. At least one hydrogen atom in the aryloxy group may be substituted with those substituents already described above in connection with the term “substituted”.

The C6-30 heteroaryl group in Formula 1 refers to an organic compound including at least one heteroatom selected from nitrogen (N), oxygen (O), phosphorous (P), and sulfur (S), with the remainder of the aryl ring atoms being carbon. An example of the C6-30 heteroaryl group includes pyridyl. At least one hydrogen atom in the heteroaryl group may be substituted with those substituents already described above in connection with the term “substituted”.

In some embodiments, the phosphorous compound as the additive of the electrolyte is at least one of the compounds represented by Formulae 2 to 6 below:

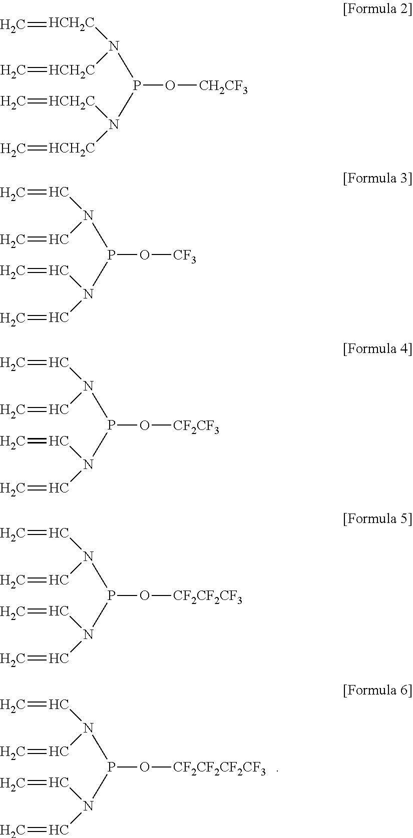

The additive of Formula 1 may form a thin film on a surface of the positive electrode through coordination of unshared electron pairs of the nitrogen (N) and oxygen (O) atoms bound to the phosphorous (P) atom with lithium ions dissociated during charging and discharging of a lithium secondary battery. In some embodiments, the double bond in the additive of Formula 1 is transformed into a single bond by receiving electrons from negative ions dissociated in the nonaqueous organic solvent of the electrolyte, thus forming a solid electrolyte interphase (SEI) layer on the surface of the negative electrode.

An amount of the additive of Formula 1 may be from about 0.3 wt % to about 13 wt % based on a total weight of the electrolyte, and in some embodiments, from about 0.5 wt % to about 10 wt % based on the total weight of the electrolyte. When the amount of the additive is within these ranges, a thin film may be formed on a surface of the positive and/or negative electrode to prevent or reduce direct contact with the electrolyte and to facilitate transfer of lithium ions between the positive and/or negative electrode and the electrolyte.

In some embodiments, the lithium salt includes LiPF₆, LiBF₄, LiSbF₆, LiAsF₆, LiCF₃SO₃, Li(CF₃SO₂)₃C, Li(CF₃SO₂)₂N, LiC₄F₉SO₃, LiClO₄, LiAlO₄, LiAlCl₄, LiBPh₄, LiN(CₓF₂ₓ₊₁SO₂)(CₓF_{2y+1}SO₂) (where x and y are non-zero natural numbers), LiCl, Lil, LIBOB (lithium bisoxalato borate), or a combination thereof.

In some embodiments, the lithium salt is dissolved in the nonaqueous organic solvent and serves as a source of lithium ions in a lithium battery, thereby enabling the basic operation of the battery. In addition, in some embodiments, the lithium salt facilitates the migration of lithium ions between the positive electrode and the negative electrode. Other lithium salts suitable for facilitating the migration of lithium ions between the positive electrode and the negative electrode in a lithium battery may also be used.

The lithium salt may be used as a supporting electrolytic salt. A concentration of the lithium salt may be within a range suitable for operation of a lithium battery, and is not specifically limited. For example, a concentration of the lithium salt may be from about 0.1M to about 2.0M in the electrolyte. When the concentration of the lithium salt is within this range, the electrolyte may have improved performance, and a viscosity of the electrolyte suitable to improve mobility of lithium ions may be maintained.

In some embodiments, the nonaqueous organic solvent may include a carbonate-based solvent, an ester-based solvent, an ether-based solvent, a ketone-based solvent, an alcohol-based solvent, an aprotic solvent, or a combination thereof.

The nonaqueous organic solvent, which may serve as a migration medium of ions involved in electrochemical reactions of the battery, may be selected from various nonaqueous organic solvents suitable for use in a lithium battery.

Examples of the carbonate-based solvent include dimethyl carbonate (DMC), diethyl carbonate (DEC), dipropyl carbonate (DPC), methylpropyl carbonate (MPC), ethylpropyl carbonate (EPC), methyl ethyl carbonate (MEC), ethylene carbonate (EC), propylene carbonate (PC), and butylene carbonate (BC). Examples of the ester-based solvent include methyl acetate, ethyl acetate, n-propyl acetate, dimethyl acetate, methyl propionate, ethyl propionate, γ-butyrrolactone, decanolide, valerolactone, mevalonolactone, and caprolactone. Examples of the ether-based solvent include dibutyl ether, tetraglyme, diglyme, dimethoxyethane, 2-methyltetrahydrofuran, and tetrahydrofuran. An example of the ketone-based solvent includes cyclohexanone.

Examples of the alcohol-based solvent include ethyl alcohol and isopropyl alcohol. Examples of the aprotic solvent include nitriles, such as R—CN (wherein R is a linear, branched or cyclic C2-C20 hydrocarbon group, which may have a double bond, an aromatic ring, or an ether bond); amides, such as dimethylformamide; dioxolanes, such as 1,3-dioxolane; and sulfolanes.

These nonaqueous organic solvents may be used alone or in combination of at least two. A mixing ratio of the nonaqueous organic solvents used in combination may be varied in accordance with a desired performance of a battery.

For example, the carbonate-based solvent may be a combination of a cyclic carbonate and a linear chain carbonate. For example, a combination of a cyclic carbonate and a linear chain carbonate in a volume ratio of about 1:1 to about 1:9 may be used to attain a high-performance electrolyte.

The nonaqueous organic solvent may further include an aromatic hydrocarbon-based organic solvent in a carbonate-based solvent. In this regard, the carbonate-based solvent and the aromatic hydrocarbon-based organic solvent may be mixed, for example, in a volume ratio of about 1:1 to about 30:1.

An example of the aromatic hydrocarbon-based organic solvent includes an aromatic hydrocarbon-based compound represented by Formula 7 below:

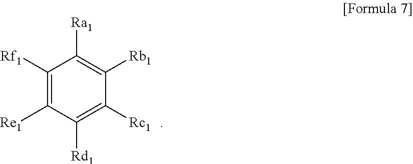

In Formula 7 above, Rₐ₁ to R_{f1} may be each independently selected from a hydrogen atom, a halogen atom, a C1-C10 alkyl group, and a haloalkyl group.

Examples of the aromatic hydrocarbon-based organic solvent include benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, toluene, a fluorotoluene, 2,3-difluorotoluene, 2,4-difluorotoluene, 2,5-difluorotoluene, 2,3,4-trifluorotoluene, 2,3,5-trifluorotoluene, a chlorotoluene, 2,3-dichlorotoluene, 2,4-dichlorotoluene, 2,5-dichlorotoluene, 2,3,4-trichlorotoluene, 2,3,5-trichlorotoluene, an iodotoluene, 2,3-diiodotoluene, 2,4-diiodotoluene, 2,5-diiodotoluene, 2,3,4-triiodotoluene, 2,3,5-triiodotoluene, a xylene, and combinations thereof.

Hereinafter, embodiments of a lithium secondary battery including any of the electrolytes according to the above-described embodiments are described in more detail.

According to another embodiment, a lithium secondary battery includes a positive electrode containing a positive active material that allows intercalation and deintercalation of lithium ions; a negative electrode containing a negative active material that allows intercalation and deintercalation of lithium ions; and an electrolyte disposed between the positive electrode and the negative electrode, the electrolyte including a lithium salt, a nonaqueous organic solvent, and a compound of Formula 1 as an additive:

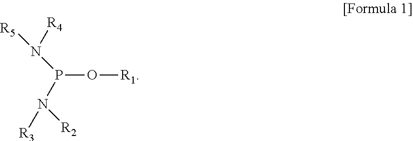

In Formula 1, R₁, R₂, R₃, R₄, and R₅ are each independently selected from a hydrogen atom, a halogen atom, a hydroxy group, a cyano group, —OR (where R is a C1-C10 alkyl group or a C6-C20 aryl group), —C(═O)Rₐ, —C(═O)ORₐ, —OCO(ORₐ), —(X)ₙ—NH₂ (where X is a C1-C10 alkyl group or a C1-C10 alkoxy group, and n is an integer from 0 to 10), —(X₁)ₙ—C(Rₐ)₃ (where X₁ is a C1-C10 alkyl group or a C1-C10 alkoxy group, and n is an integer from 0 to 10), —(X₂)ₙ—CH═CH₂ (where X₂ is a C1-C10 alkyl group or a C1-C10 alkoxy group, and n is an integer from 1 to 10), —C═N(Rₐ), —SRₐ, —S(═O)Rₐ, —S(═O)₂Rₐ, a substituted or unsubstituted C1-C20 alkyl group, a substituted or unsubstituted C1-C20 alkoxy group, a substituted or unsubstituted C2-C20 alkenyl group, a substituted or unsubstituted C2-C20 alkynyl group, a C2-C20 alkylene oxide group, a substituted or unsubstituted C3-C30 cycloalkyl group, a substituted or unsubstituted C6-C30 aryl group, a substituted or unsubstituted C6-C30 aryloxy group, and a substituted or unsubstituted C6-C30 heteroaryl group, where Rₐ is selected from a hydrogen atom, a halogen atom, a C1-C10 alkyl group, and a C6-C20 aryl group.

The detailed descriptions of the additive of Formula 1 including the additives of Formulae 2 to 6, amounts of these additives of Formula 1, the lithium salt, and the nonaqueous organic solvent include those already described above.

An example of a synthesis of the additive in the electrolyte is represented by Reaction Scheme 1 below with reference to the compound of Formula 2 above as an example.

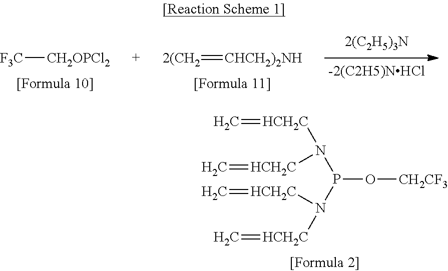

As illustrated in Reaction Scheme 1, the compound of Formula 2 may be obtained through elimination of hydrogen (H) atom from an amine compound and chlorine (Cl) atom from a phosphorous compound in a solvent of 2 mole equivalents of (C₂H₅)₃N with respect to the chorine (Cl) atom containing compound in Reaction Scheme 1.

However, embodiments of the present invention are not limited to the synthesis shown in Reaction Scheme 1. For example, a synthesis of the additive in the electrolyte may also be represented by Reaction Scheme 2 below, with reference to the compound of Formula 1 as an example.

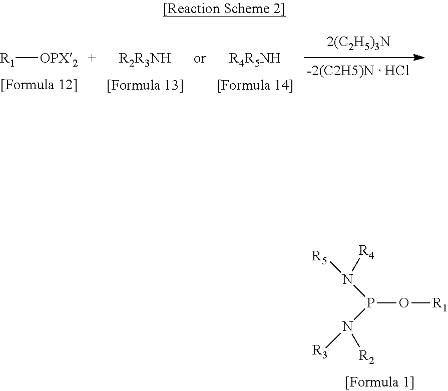

In the above Reaction Scheme 2, X′ is selected from a halogen (such as chlorine, bromine, or iodine) and other suitable leaving groups.

Additionally, other suitable bases may be used in Reaction Scheme 1 or Reaction Scheme 2, instead of triethylamine.

The positive electrode and/or the negative electrode may have a thin film on a surface thereof. The thin film may be partially or wholly formed from the additive in the electrolyte, not formed through an additional process of coating a surface of the positive electrode or negative electrode.

Since the compounds of Formulae 1 to 6 used as the additive in the electrolyte of the lithium secondary battery are involved in forming a thin film on the surface of the positive or negative electrode, the amount of the compounds of Formulae 1 to 6 may be reduced after operation of the lithium secondary battery.

For example, the amount of the compounds of Formulae 1 to 6 in the electrolyte after operation of the lithium secondary battery may be less than that before the operation of the lithium secondary battery.

In some embodiments, the thin film in the lithium secondary battery may be formed on the surface of the positive electrode through coordination of some or all of the non-covalent electron pairs of the nitrogen (N) and oxygen (O) atoms in the additive of the electrolyte with lithium ions dissociated during initial charging of the lithium secondary battery. In some other embodiments, the double bond in the additive of Formula 1 is transformed into a single bond by receiving electrons from negative ions dissociated in the nonaqueous organic solvent of the electrolyte during initial charging, thus forming a SEI layer on the surface of the negative electrode. Thus, the lithium secondary battery may be improved in high-rate characteristics, high-temperature storage characteristics, and/or lifetime characteristics.

For example, the thin film formed on the surface of the positive or negative electrode may have a thickness of about 0.05 nm to about 100 nm, and in some embodiments, a thickness of about 0.1 nm to about 80 nm, and in some other embodiments, a thickness of about 0.5 nm to about 50 nm. When the thickness of the thin film is within these ranges, the thin film may not adversely affect the transfer of lithium ions and may effectively prevent or reduce direct contact between the electrolyte and the positive or negative electrode.

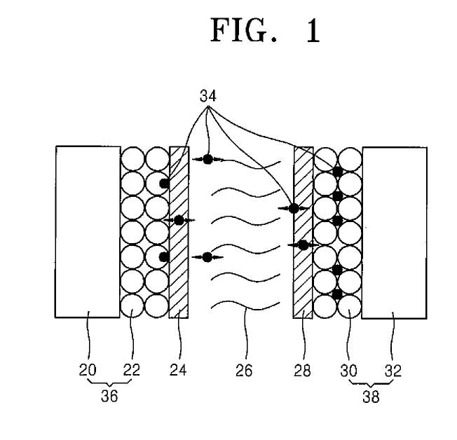

FIG. 1 is a schematic cross-sectional view illustrating thin films formed on surfaces of a positive electrode and a negative electrode of a lithium secondary battery, according to an embodiment of the present invention. Referring to FIG. 1, the lithium secondary battery, which uses an electrolyte including one of the additives according to embodiments herein described, may include durable thin films 24 and 28 on the surfaces of a positive electrode 36 and surfaces of a negative electrode 38, respectively. In FIG. 1, the positive electrode 36 includes a positive electrode current collector 20 and a positive active material layer 22, and the negative electrode 38 includes a negative electrode current collector 32 and a negative active material layer 30. Lithium ions 34 may be effectively transferred between the positive electrode 36 and the negative electrode 39 via an electrolyte 26.

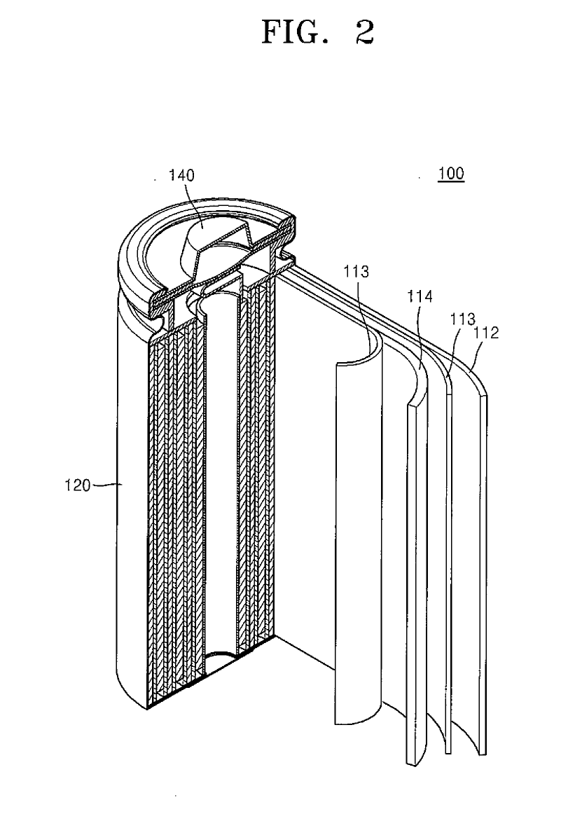

FIG. 2 is an exploded perspective view of a lithium secondary battery 100 according to an embodiment of the present invention. Although the lithium secondary battery 100 illustrated in FIG. 2 is cylindrical, embodiments of present invention are not limited thereto, and lithium secondary batteries according to embodiments of the present invention may be, for example, a rectangular battery or a pouch battery.

Lithium secondary batteries may be classified as lithium ion batteries, lithium ion polymer batteries, or lithium polymer batteries, according to the type of separator and/or electrolyte included therein. In addition, lithium batteries may be classified as cylindrical batteries, rectangular batteries, coin batteries, or pouch batteries, according to the shape thereof. Lithium batteries may also be classified as either bulky batteries or thin film batteries, according to the size and/or thickness thereof. Lithium secondary batteries according to embodiments of the present invention include lithium batteries having any suitable size and/or shape. The structure and a method of manufacturing include any suitable structure and method of manufacturing of a lithium secondary battery, and thus a further description thereof is not be included here.

Referring to FIG. 2, the lithium secondary battery 100 in cylindrical form includes a negative electrode 112; a positive electrode 114; a separator 113 disposed between the negative electrode 112 and the positive electrode 114; and an electrolyte impregnated into the negative electrode 112, the positive electrode 114, and the separator 113; a battery case 120; and a sealing member 140 sealing the battery case 120. The lithium secondary battery 100 may be manufactured by sequentially stacking the negative electrode 112, the positive electrode 114, and the separator 113 on one another to form a stack, rolling the stack in a spiral form, and placing the rolled-up stack in the battery case 120.

The negative electrode 112 includes a current collector and a negative active material layer disposed on the current collector. The negative active material layer includes a negative active material.

The current collector of the negative electrode 112 may be a copper current collector, a nickel current collector, or a SUS current collector, depending on a voltage level of the lithium secondary battery. In some embodiments, the current collector of the negative electrode 112 is a copper current collector.

The negative active material is not specifically limited, and any negative active material suitable for use in a lithium battery may be used. Examples of the negative active material include lithium metal, a metal that is alloyable with lithium, a transition metal oxide, a material that allows doping or undoping of lithium, a material that allows reversible intercalation and deintercalation of lithium ions, and the like.

Examples of the transition metal oxide include vanadium oxide, lithium vanadium oxide, and the like. Examples of the material that allows doping or undoping of lithium include silicon (Si), SiOₓ (0<x<2), an Si—Y alloy (where Y is an alkali metal, an alkali earth metal, a Group 13 element, a Group 14 element excluding Si, a transition metal, a rare earth element, or combinations thereof), Sn, SnO₂, an Sn—Y alloy (where Y is an alkali metal, an alkali earth metal, a Group 13 element, a Group 14 element excluding Si, a transition metal, a rare earth element, or a combination thereof), and combinations of at least one of these materials with SiO₂. Y may be magnesium (Mg), calcium (Ca), strontium (Sr), barium (Ba), radium (Ra), scandium (Sc), yttrium (Y), titanium (Ti), zirconium (Zr), hafnium (Hf), rutherfordium (Rf), vanadium (V), niobium (Nb), tantalum (Ta), dubnium (Db), chromium (Cr), molybdenum (Mo), tungsten (W), seaborgium (Sg), technetium (Tc), rhenium (Re), bohrium (Bh), iron (Fe), lead (Pb), ruthenium (Ru), osmium (Os), hassium (Hs), rhodium (Rh), iridium (Ir), palladium (Pd), platinum (Pt), copper (Cu), silver (Ag), gold (Au), zinc (Zn), cadmium (Cd), boron (B), aluminum (Al), gallium (Ga), tin (Sn), indium (In), titanium (Ti), germanium (Ge), phosphorus (P), arsenic (As), antimony (Sb), bismuth (Bi), sulfur (S), selenium (Se), tellurium (Te), polonium (Po), or a combination thereof.

The material that allows reversible intercalation and deintercalation of lithium ions may be any carbonaceous negative active material suitable for use in a lithium ion secondary battery. Examples of this material include crystalline carbon, amorphous carbon, and combinations thereof. Examples of the crystalline carbon include graphite, such as natural graphite or artificial graphite that are in amorphous, plate, flake, spherical or fibrous form. Examples of the amorphous carbon include soft carbon (carbon sintered at low temperatures), hard carbon, meso-phase pitch carbides, and sintered corks.

The negative active material layer may include a binder, and may also include a conducting agent.

The binder may bind negative active material particles to one another and to a current collector. Non-limiting examples of the binder include polyvinyl alcohol, carboxymethyl cellulose, hydroxypropyl cellulose, diacetyl cellulose, polyvinyl chloride, carboxylated polyvinyl chloride, polyvinyl fluoride, a polymer including ethylene oxide, polyvinylpyrrolidone, polyurethane, polytetrafluoroethylene, polyvinylidene fluoride, polyethylene, polypropylene, styrene-butadiene rubber (SBR), acrylated SBR, epoxy resin, and nylon.

The conducting agent may be used to provide conductivity to the negative electrode. Any suitable electron conducting material that does not induce chemical change in batteries may be used. Examples of the conducting agent include natural graphite, artificial graphite, carbon black, acetylene black, ketjen black, carbon fibers, metal powder or metal fibers of copper (Cu), nickel (Ni), aluminum (Al), silver (Ag), and the like, conductive materials, such as a polyphenylene derivative, and combinations thereof. The current collector may be selected from a copper foil, a nickel foil, a stainless steel foil, a titanium foil, a nickel foam, a copper foam, a polymeric substrate coated with a conductive metal, and a combination thereof.

Amounts of the negative active material, the binder, and the conducting agent include those suitable for use in lithium secondary batteries. For example, a weight ratio of the negative active material to a mixture of the conducting agent and the binder may be from about 98:2 to about 92:8. A mixing ratio of the conducting agent to the binder may be from about 1:1.5 to about 1:3. However embodiments of the present invention are not limited thereto.

The positive electrode 114 may include a current collector and a positive active material layer disposed on the current collector.

Al (aluminum) may be used as the current collector, but the embodiments of the present invention are not limited thereto.

The positive active material is not specifically limited, and may be any positive active material suitable for use in a lithium secondary battery. For example, the positive active material may include a compound that allows reversible intercalation and deintercalation of lithium. The positive active material may include at least one of a composite oxide of lithium with a metal selected from Co, Mn, Ni, and a combination thereof. For example, the positive active material may include at least one compound represented by the following formulae: LiₐA_{1-b}B_{b}D₂ (where 0.90≦a≦1.8, and 0≦b≦0.5); LiₐE_{1-b}B_{b}O_{2-c}D_{c} (where 0.90≦a≦1.8, 0≦b≦0.5, and 0≦c≦0.05); LiE_{2-b}B_{b}O_{4-c}D_{c} (where 0≦b≦0.5, and 0≦c≦0.05); LiₐNi_{1-b-c}Co_{b}B_{c}D_{α} (where 0.90≦a≦1.8, 0≦b≦0.5, 0≦c≦0.05, and 0<α≦2); LiₐNi_{1-b-c}Co_{b}B_{c}O_{2-α}F_{α} (where 0.90≦a≦1.8, 0≦b≦0.5, 0≦c≦0.05, and 0<α<2); LiₐNi_{1-b-c}Co_{b}B_{c}O_{2-α}F₂ (where 0.90≦a≦1.8, 0≦b≦0.5, 0≦c≦0.05, and 0<α<2); LiₐNi_{1-b-c}Mn_{b}B_{c}D_{α} (where 0.90≦a≦1.8, 0≦b≦0.5, 0≦c≦0.05, and 0<α≦2); LiₐNi_{1-b-c}Mn_{b}B_{c}O_{2-α}F_{α} (where 0.90≦a≦1.8, 0≦b≦0.5, 0≦c≦0.05, and 0<α<2); LiₐNi_{1-b-c}Mn_{b}B_{c}O_{2-α}F₂ (where 0.90≦a≦1.8, 0≦b≦0.5, 0≦c≦0.05, and 0<α<2); LiₐNi_{b}E_{c}G_{d}O₂(where 0.90≦a≦1.8, 0≦b≦0.9, 0≦c≦0.5, and 0.001≦d≦0.1); LiₐNi_{b}Co_{c}Mn_{d}GₑO₂(where 0.90≦a≦1.8, 0≦b≦0.9, 0≦c≦0.5, 0≦d≦0.5, and 0.001≦e≦0.1); LiₐNiG_{b}O₂ (where 0.90≦a≦1.8, and 0.001≦b≦0.1); LiₐCoG_{b}O₂ (where 0.90≦a≦1.8, and 0.001≦b≦0.1); LiₐMnG_{b}O₂ (where 0.90≦a≦1.8, and 0.001≦b≦0.1); LiₐMn₂G_{b}O₄ (where 0.90≦a≦1.8, and 0.001≦b≦0.1); QO₂; QS₂; LiQS₂; V₂O₅; LiV₂O₅; LilO₂; LiNiVO₄; Li_{(3-f)}J₂(PO₄)₃ (where 0≦f≦2); Li_{(3-f)}Fe₂(PO₄)₃ (where 0≦f≦2); or LiFePO₄.

Non-limiting examples of the positive active material include LiCoO₂, LiNi_{1-X}Co_{X}O₂ (where 0≦x<1), Li_{1-X}M_{X}O₂(M is Mn or Fe, and 0.03<x<0.1), Li[Ni_{X}Co_{1-2X}Mn_{X}]O₂ (where 0<x<0.5), Li[Ni_{X}Mn_{X}]O₂(where 0<x≦0.5), Li₁₊ₓ(M)_{1-y}O_{z} (where 0<x≦1, 0≦y<1, 2≦z≦4, and M is a transition metal), LiM₂O₄ (M is Ti, V, or Mn), LiM_{X}Mn_{2-X}O₄ (where M is a transition metal), LiFePO₄, LiMPO₄ (M is Mn, Co, or Ni). V₂O₅, V₂O₃, VO₂(B), V₆O₁₃, V₄O₉, V₃O₇, Ag₂V₄O₁₁, AgVO₃, LiV₃O₅, δ-Mn_{y}V₂O₅, δ-NH₄V₄O₁₀, Mn_{0.8}V₇O₁₆, LiV₃O₈, CuₓV₂O₅, CrₓV₆O₁₃, M₂(XO₄)₃ (M is a transition metal, and X is S, P, As, Mo, W, or the like), and Li₃M₂(PO₄)₃(where M is Fe, V, Ti, or the like).

Examples of the positive active material include LiMn₂O₄, LiNi₂O₄, LiCoO₂, LiNiO₂, LiMnO₂, Li₂MnO₃, LiFePO₄, Li₁₊ₓ(Ni, Co, Mn)₁₋ₓO₂(where 0.05≦x≦0.2), and LiNi_{0.5}Mn_{1.5}O₄, but are not limited thereto.

In the formulae above, A is selected from nickel (Ni), cobalt (Co), manganese (Mn), and combinations thereof; B is selected from aluminum (Al), nickel (Ni), cobalt (Co), manganese (Mn), chromium (Cr), iron (Fe), magnesium (Mg), strontium (Sr), vanadium (V), a rare earth element, and combinations thereof; D is selected from oxygen (O), fluorine (F), sulfur (S), phosphorus (P), and combinations thereof; E is selected from cobalt (Co), manganese (Mn), and combinations thereof; F is selected from fluorine (F), sulfur (S), phosphorus (P), and combinations thereof; G is selected from aluminum (Al), chromium (Cr), manganese (Mn), iron (Fe), magnesium (Mg), lanthanum (La), cerium (Ce), strontium (Sr), vanadium (V), and combinations thereof; Q is selected from titanium (Ti), molybdenum (Mo), manganese (Mn), and combinations thereof; I is selected from chromium (Cr), vanadium (V), iron (Fe), scandium (Sc), yttrium (Y), and combinations thereof; and J is selected from vanadium (V), chromium (Cr), manganese (Mn), cobalt (Co), nickel (Ni), copper (Cu), and combinations thereof.

The compounds listed above as positive active materials may have a coating layer on a surface thereof. Alternatively, a mixture of a compound not having a coating layer and a compound having a coating layer may be used, the compounds being selected from the compounds listed above. The coating layer may include at least one compound of a coating element selected from an oxide, a hydroxide, an oxyhydroxide, an oxycarbonate, and a hydroxycarbonate of the coating element. The compounds for the coating layer may be amorphous or crystalline. The coating element for the coating layer may include magnesium (Mg), aluminum (Al), cobalt (Co), potassium (K), sodium (Na), calcium (Ca), silicon (Si), titanium (Ti), vanadium (V), tin (Sn), germanium (Ge), gallium (Ga), boron (B), arsenic (As), zirconium (Zr), or mixtures thereof. The coating layer may be formed using any method that does not adversely affect the physical properties of the positive active material when a compound of the coating element is used. For example, the coating layer may be formed using a spray coating method, a dipping method, or the like.

The positive active material layer may include a binder and a conducting agent.

The positive active material may have an operation voltage of about 4.0V to about 5.5V. In some embodiments, the positive active material having an operation voltage within this range is an over-lithiated oxide (OLO)-based positive active material, a 5V-positive active material having a spinel structure.

The binder may bind positive active material particles to one another and to a current collector. Non-limiting examples of the binder include polyvinyl alcohol, carboxymethyl cellulose, hydroxypropyl cellulose, diacetyl cellulose, polyvinyl chloride, carboxylated polyvinyl chloride, polyvinyl fluoride, a polymer including ethylene oxide, polyvinylpyrrolidone, polyurethane, polytetrafluoroethylene, polyvinylidene fluoride, polyethylene, polypropylene, styrene-butadiene rubber (SBR), acrylated SBR, epoxy resin, and nylon.

The conducting agent may be used for providing conductivity to the positive electrode. Any suitable electron conducting material that does not induce chemical change in batteries may be used. Examples of the conducting agent include natural graphite, artificial graphite, carbon black, acetylene black, ketjen black, carbon fibers, metal powder or metal fibers of copper (Cu), nickel (Ni), aluminum (Al), or silver (Ag), conductive materials such as polyphenylene derivatives, and combinations thereof.

Amounts of the positive active material, the binder, and the conducting agent may be those suitable for use in lithium batteries. For example, a weight ratio of the positive active material to a mixture of the conducting agent and the binder may be from about 98:2 to about 92:8. A mixing ratio of the conducting agent to the binder may be from about 1:1.5 to about 1:3. However embodiments of the present invention are not limited thereto.

The negative electrode 112 and the positive electrode 114 may be each manufactured by mixing an active material, a binder, and a conducting agent in a solvent to prepare an active material composition, and coating the active material composition on a current collector. The method of manufacturing includes any suitable method of manufacturing an electrode, and thus a further description thereof is not provided. N-methylpyrrolidione may be used as the solvent, but embodiments of the present invention are not limited thereto.

A separator may be present between the positive electrode and the negative electrode depending on the type of the lithium battery. The separator may be a monolayer separator or a multilayer separator, including at least two layers of polyethylene, polypropylene, polyvinylidene fluoride, or a combination thereof. The multilayer may include two or more layers of a same kind (e.g., two or more polyethylene layers) or may be a mixed multilayer (i.e., including at least two different kinds of layers (e.g., a polyethylene layer and a polyvinylidene fluoride layer)). For example, the separator may be a two-layered separator including polyethylene and polypropylene layers, a three-layered separator including polyethylene, polypropylene and polyethylene layers, or a three-layered separator including polypropylene, polyethylene and polypropylene layers.

One or more embodiments of the present invention are now be described in detail with reference to the following examples. However, these examples are not intended to limit the scope of the present invention.

### EXAMPLES

### Preparation of Electrolyte for Lithium Secondary Battery

### Example 1

### Electrolyte for Lithium Secondary Battery

About 0.5 wt % of a compound represented by Formula 2 below was added as an additive into a mixed organic solvent of about 1.5 volume % of ethylene carbonate, about 6 volume % of ethyl methyl carbonate and about 2.5 volume % of dimethyl carbonate, which was followed by adding 1.3 M LiPF₆ as a lithium salt to prepare an electrolyte for a lithium secondary battery.

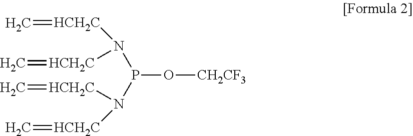

### Example 2

### Electrolyte for Lithium Secondary Battery

An electrolyte for a lithium secondary battery was prepared in the same manner as in Example 1, except that about 0.5 wt % of a compound represented by Formula 3 below was used as an additive, instead of about 0.5 wt % of the compound of Formula 2.

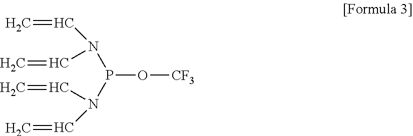 [SMILES: C=CN(C=C)P(OC(F)(F)F)N(C=C)C=C]

### Example 3

### Electrolyte for Lithium Secondary Battery

An electrolyte for a lithium secondary battery was prepared in the same manner as in Example 1, except that about 0.5 wt % of a compound represented by Formula 4 below was used as an additive, instead of about 0.5 wt % of the compound of Formula 2.

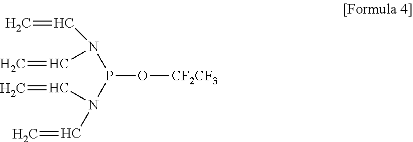

### Example 4

### Electrolyte for Lithium Secondary Battery

An electrolyte for a lithium secondary battery was prepared in the same manner as in Example 1, except that about 0.5 wt % of a compound represented by Formula 5 below was used as an additive, instead of about 0.5 wt % of the compound of Formula 2.

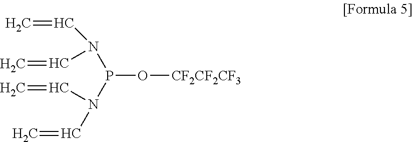

### Example 5

### Electrolyte for Lithium Secondary Battery

An electrolyte for a lithium secondary battery was prepared in the same manner as in Example 1, except that about 0.5 wt % of a compound represented by Formula 6 below was used as an additive, instead of about 0.5 wt % of the compound of Formula 2.

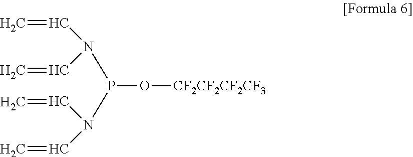

### Example 6

### Electrolyte for Lithium Secondary Battery

An electrolyte for a lithium secondary battery was prepared in the same manner as in Example 1, except that about 1 wt % of the compound of Formula 2 was used as an additive instead of about 0.5 wt % of the compound of Formula 2.

### Example 7

### Electrolyte for Lithium Secondary Battery

An electrolyte for a lithium secondary battery was prepared in the same manner as in Example 1, except that about 2 wt % of the compound of Formula 2 was used as an additive, instead of about 0.5 wt % of the compound of Formula 2.

### Example 8

### Electrolyte for Lithium Secondary Battery

An electrolyte for a lithium secondary battery was prepared in the same manner as in Example 1, except that about 5 wt % of the compound of Formula 2 was used as an additive, instead of about 0.5 wt % of the compound of Formula 2.

### Example 9

### Electrolyte for Lithium Secondary Battery

An electrolyte for a lithium secondary battery was prepared in the same manner as in Example 1, except that about 10 wt % of the compound of Formula 2 was used as an additive, instead of about 0.5 wt % of the compound of Formula 2.

### Comparative Example 1

### Electrolyte for Lithium Secondary Battery

1.3 M LiPF₆ was added as a lithium salt into a mixed organic solvent of about 1.5 volume % of ethylene carbonate, about 6 volume % of ethyl methyl carbonate and about 2.5 volume % of dimethyl carbonate to prepare an electrolyte for a lithium secondary battery.

### Comparative Example 2

### Electrolyte for Lithium Secondary Battery

About 0.1 wt % of the compound of Formula 2 was added as an additive into a mixed organic solvent of about 1.5 volume % of ethylene carbonate, about 6 volume % of ethyl methyl carbonate and about 2.5 volume % of dimethyl carbonate, which was followed by adding 1.3 M LiPF₆ as a lithium salt to prepare an electrolyte for a lithium secondary battery.

### Comparative Example 3

### Electrolyte for Lithium Secondary Battery

About 15 wt % of the compound of Formula 2 was added into a mixed organic solvent of about 1.5 volume % of ethylene carbonate, about 6 volume % of ethyl methyl carbonate and about 2.5 volume % of dimethyl carbonate, which was followed by adding 1.3 M LiPF₆ as a lithium salt to prepare an electrolyte for a lithium secondary battery.

### Comparative Example 4

### Electrolyte for Lithium Secondary Battery

An electrolyte for a lithium secondary battery was prepared in the same manner as in Example 1, except that about 0.5 wt % of a compound represented by Formula 8 below was used as an additive, instead of about 0.5 wt % of the compound of Formula 2.

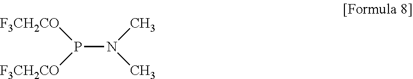

### Comparative Example 5

### Electrolyte for Lithium Secondary Battery

An electrolyte for a lithium secondary battery was prepared in the same manner as in Example 1, except that about 0.5 wt % of a compound represented by Formula 9 below was used as an additive, instead of about 0.5 wt % of the compound of Formula 2.

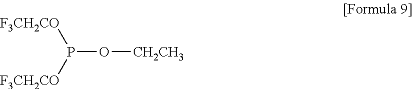

### Manufacturing of a Lithium Secondary Battery

### Example 10

### Manufacturing of a Lithium Secondary Battery

Li₁₊ₓ(Ni, Co, Mn)₁₋ₓO₂ (0.05≦x≦0.2) powder as a positive active material, 5 wt % of polyvinylidene fluoride (PVdF) as a binder dissolved in N-methylpyrrolidone (NMP), and a conducting agent (Denka black), were mixed in a weight ratio of 92:4:4, respectively, in an agate mortar to prepare a slurry. The slurry was bar-coated on an aluminum foil having a thickness of about 15 μm. The aluminum foil coated with the slurry was dried in a 90° C. vacuum oven for about 2 hours to evaporate NMP (first drying), and then in a 120° C. vacuum oven for about 2 hours (second drying) until the NMP was completely evaporated. The resulting electrode was subjected to pressing and punching to obtain a positive electrode for a coin cell, the positive electrode having a thickness of about 105 μm and a diameter of about 1.5 cm.

The positive electrode having a diameter of about 1.5 cm, a graphite negative electrode having a diameter of about 1.6 cm (ICG1OH, available from Mitsubishi), a polyethylene separator (Celgard 2320, available from Celgard), and the electrolyte prepared in Example 1 were used to manufacture a coin cell.

### Examples 11 to 18

### Lithium Secondary Batteries

Lithium secondary batteries were manufactured in the same manner as in Example 10, except that the electrolytes of Examples 2 to 9 were used, respectively.

### Comparative Examples 6 to 10

### Lithium Secondary Batteries

Lithium secondary batteries were manufactured in the same manner as in Example 10, except that the electrolytes of Comparative Examples 1 to 5 were used, respectively.

### Battery Performance Test

### Evaluation Example 1

### Confirmation of Film Formation

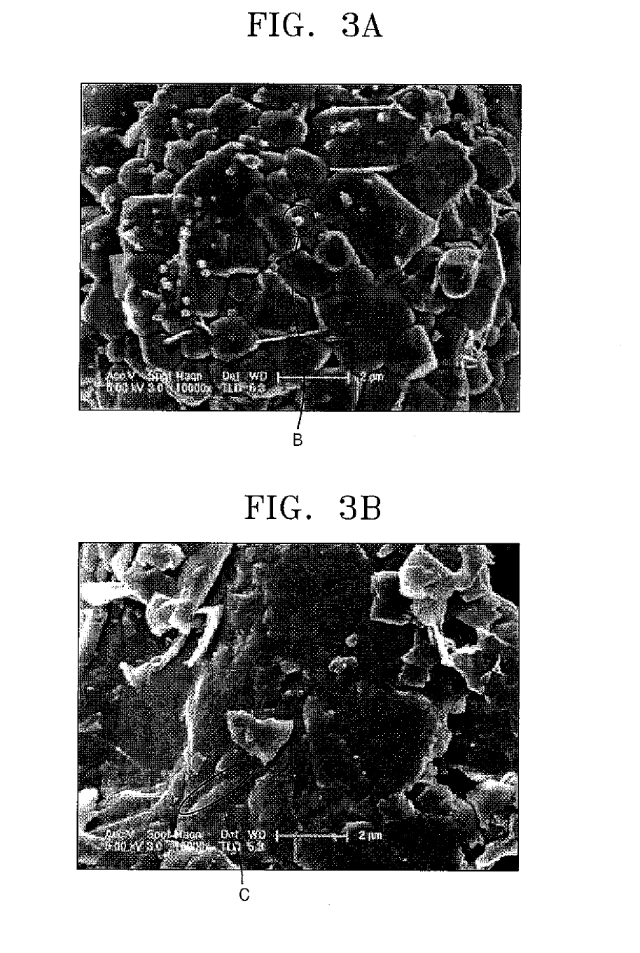

The lithium secondary battery of Example 10 was disassembled in a glove box to collect the positive electrode and negative electrode, which were then washed with dimethyl carbonate to remove the electrolyte and lithium salt from the positive and negative electrodes. After drying, surfaces of the positive electrode and negative electrode were observed using scanning electron microscopy (SEM). The results are shown in FIGS. 3A and 3B.

Referring to FIGS. 3A and 3B, surfaces of the positive and negative active materials were found to have thin films (for example, in regions denoted by “B” and “C”).

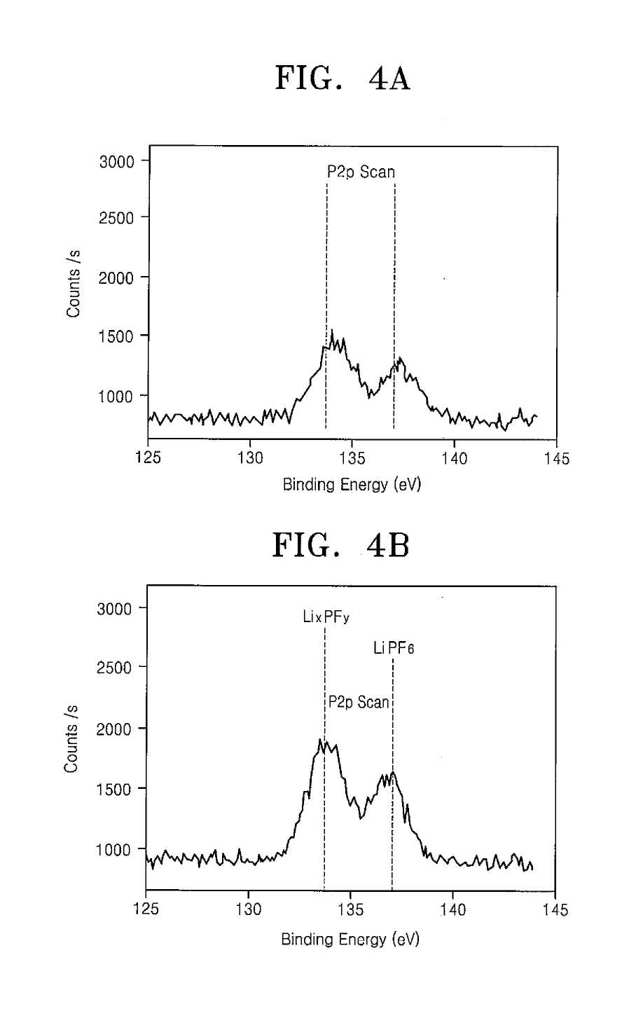

The lithium secondary batteries of Example 10 and Comparative Example 6 were disassembled in a glove box to collect the negative electrodes, which were then washed with dimethyl carbonate to remove the electrolyte and lithium salt from the negative electrode. After drying, a reaction product was sampled from the surface of each negative electrode, and then analyzed in a vacuum by X-ray photoelectron spectroscopy (Sigma Probe, available from Thermo, UK). The results are shown in FIGS. 4A and 4B.

Referring to FIGS. 4A and 4B, the P 2p XPS spectra of the materials sampled from the surfaces of the negative electrodes of the lithium secondary batteries of Example 10 and Comparative Example 6 exhibited a LiₓPF_{y} peak (at a binding energy of about 134 eV) and a LiPF₆ peak (at a binding energy of about 137 eV), which had weaker intensities in the lithium secondary battery of Example 10 than those of the lithium secondary battery of Comparative Example 10. This indicates that the concentration of the decomposition product of the lithium salt in the thin film on the negative electrode of the lithium secondary battery of Example 10 was lower than that of the thin film on the negative electrode of the lithium secondary battery of Comparative Example 6. This result indicates that the lithium secondary battery of Example 10 may maintain the concentration of the lithium salt high after 100 cycles of charging and discharging.

### Evaluation Example 2

### Evaluation of High-Rate Characteristics

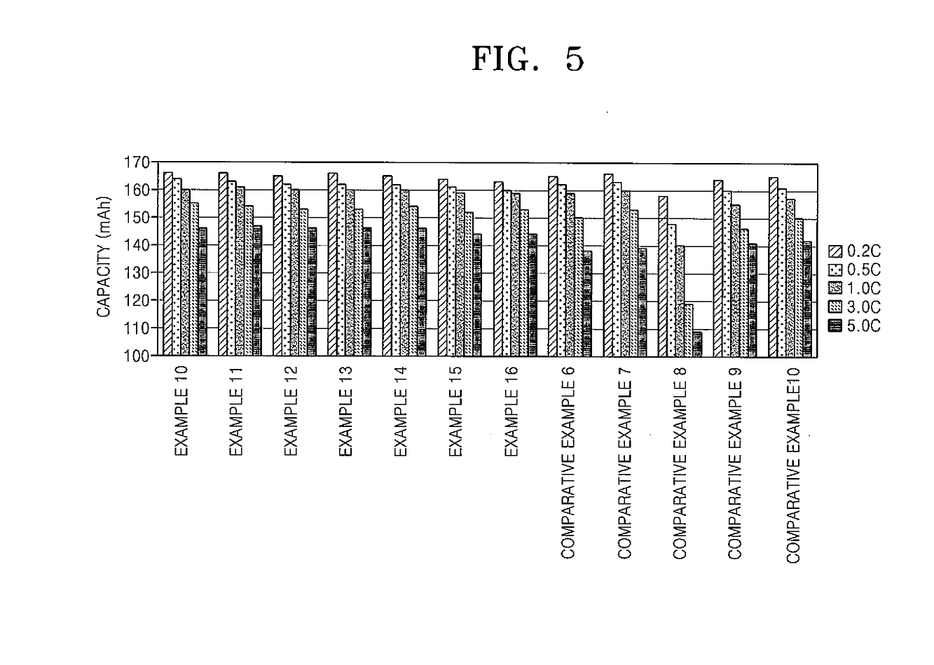

The lithium secondary batteries of Examples 10 to 16 and Comparative Examples 6 to 10 were each charged at a constant current of 0.2 C and a constant voltage of 4.2V (0.05 C cut-off), which was followed by a rest for about 10 minutes, and then discharging at constant currents of 0.2 C, 0.5 C, 1 C, 3 C, and 5 Cₜo a cut-off voltage of 2.8V, to evaluate high-rate discharge characteristics (rate capacity) of the lithium secondary batteries. The results are shown in FIG. 5 and Table 1.

TABLE 1

| | 0.2 C Discharge | 5 C Discharge | 5 C Discharge capacity/ |
|---|---|---|---|
| | capacity | capacity | 0.2 Discharge capacity × |
| Example | (mAh/g) | (mAh/g) | 100 (%) |
| Example 10 | 166 | 146 | 88 |
| Example 11 | 166 | 147 | 89 |
| Example 12 | 165 | 146 | 88 |
| Example 13 | 166 | 146 | 88 |
| Example 14 | 165 | 146 | 88 |
| Example 15 | 164 | 144 | 88 |
| Example 16 | 163 | 144 | 88 |
| Comparative | 165 | 138 | 84 |
| Example 6 | | | |
| Comparative | 166 | 139 | 84 |
| Example 7 | | | |
| Comparative | 158 | 109 | 69 |
| Example 8 | | | |
| Comparative | 164 | 141 | 86 |
| Example 9 | | | |
| Comparative | 165 | 142 | 86 |
| Example 10 | | | |

Referring to FIG. 5 and Table 1, the lithium secondary batteries of Examples 10 to 16 were found to have better high-rate characteristics than those of the lithium secondary batteries of Comparative Examples 6 to 10.

### Evaluation Example 3

### Evaluation of High-Temperature Storage Characteristics

Formation charging and discharging was performed twice on the lithium secondary batteries of Examples 10, 11, 13 to 18 and Comparative Examples 6 to 10 at room temperature. In the formation process, each of the lithium secondary batteries was charged at a constant current of about 0.1 C to a voltage of 4.2V, which was followed by constant-voltage charging to a 0.05 C current. Next, the lithium secondary battery was discharged at a constant current of 0.2 C to a voltage of 2.8V. After the formation charging and discharging, each of the lithium batteries was charged at 0.5 C and then discharged at 0.2 C until the voltage reached 2.8 V. This charging and discharging condition was termed as “standard charging and discharging condition”, and the discharge capacity in this condition was defined as a “standard capacity”.

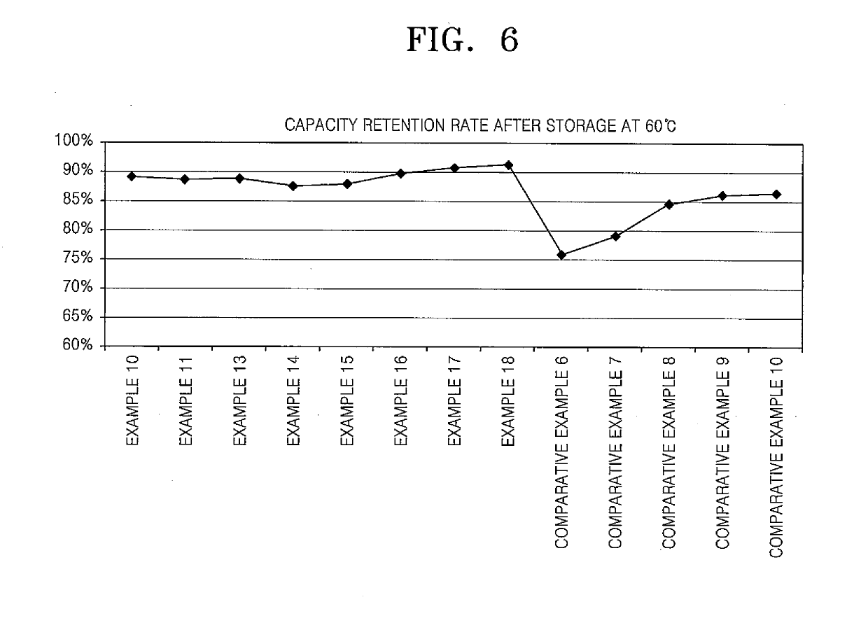

After each lithium battery was left in a constant-temperature chamber at about 60° C. for about 30 days to evaluate a discharge capacity (i.e., discharge capacity after high-temperature storage), a high-temperature capacity retention rate was calculated using Equation 1 below, as well as the discharge capacities before and after the high-temperature storage. The results are shown in FIG. 6 and Table 2.

High-temperature capacity retention rate (%)=[Discharge capacity after high-temperature storage/Standard discharge capacity]×100. Equation 1

TABLE 2

| | Standard | Discharge capacity | High-temperature |
|---|---|---|---|
| | capacity | after high-temperature | capacity retention |
| Example | (mAh) | storage (mAh) | rate (%) |
| Example 10 | 273 | 243 | 89 |
| Example 11 | 273 | 242 | 89 |
| Example 13 | 274 | 243 | 89 |
| Example 14 | 273 | 239 | 88 |
| Example 15 | 273 | 240 | 88 |
| Example 16 | 271 | 243 | 90 |
| Example 17 | 267 | 242 | 91 |
| Example 18 | 261 | 238 | 91 |
| Comparative | 270 | 205 | 76 |
| Example 6 | | | |
| Comparative | 273 | 216 | 79 |
| Example 7 | | | |
| Comparative | 252 | 213 | 85 |
| Example 8 | | | |
| Comparative | 273 | 235 | 86 |
| Example 9 | | | |
| Comparative | 273 | 236 | 86 |
| Example 10 | | | |

Referring to FIG. 6 and Table 2, the lithium secondary batteries of Examples 10, 11, and 13 to 18 were found to have better high-temperature storage characteristics than those of the lithium secondary batteries of Comparative Examples 6 to 10.

### Evaluation Example 4

### Evaluation of Lifetime Characteristics

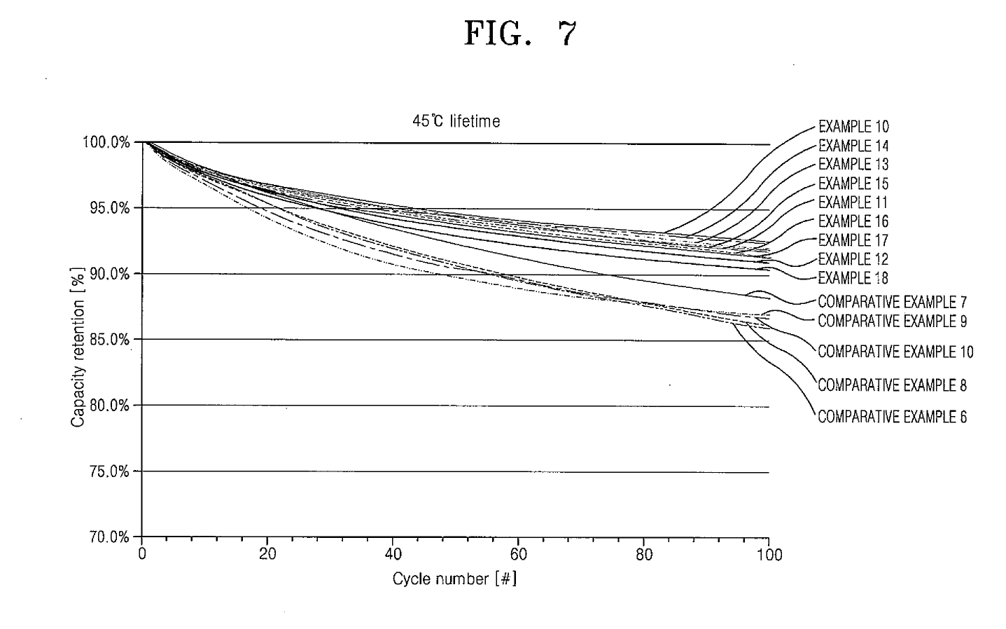

After the formation charging and discharging as in Evaluation Example 3, the lithium secondary batteries of Examples 10 to 18 and Comparative Examples 6 to 10 were each charged in a 45° C.-constant temperature chamber at about 1.5 C in the same manner as in Evaluation Example 3, which was followed by discharging at about 1.5 C to about 2.8V. Then, a discharge capacity (discharge capacity after the 1st cycle) of the lithium battery was measured. This cycle of charging and discharging was repeated to evaluate cycle characteristics of each lithium secondary battery. The discharge capacities of each lithium secondary battery at each cycle and 100^{th} cycle were measured, and used to calculate a cycle retention rate of the lithium secondary battery using Equation 2 below. The results are shown in FIG. 7 and Table 3.

Capacity retention rate (%)=[Discharge capacity at 100^{th} cycle/Discharge capacity at 1^{st} cycle]×100. Equation 2

TABLE 3

| | Discharge capacity | Discharge capacity | Capacity |
|---|---|---|---|
| Example | at 1^{st} cycle (mAh) | at 100^{th} cycle (mAh) | retention rate (%) |
| Example 10 | 261 | 242 | 93 |
| Example 11 | 259 | 239 | 92 |
| Example 12 | 258 | 236 | 91 |
| Example 13 | 254 | 235 | 93 |
| Example 14 | 255 | 236 | 93 |
| Example 15 | 255 | 235 | 92 |
| Example 16 | 255 | 234 | 92 |
| Example 17 | 255 | 234 | 92 |
| Example 18 | 255 | 231 | 91 |
| Comparative | 254 | 218 | 86 |
| Example 6 | | | |
| Comparative | 254 | 224 | 88 |
| Example 7 | | | |
| Comparative | 255 | 219 | 86 |
| Example 8 | | | |
| Comparative | 254 | 221 | 87 |
| Example 9 | | | |
| Comparative | 253 | 219 | 87 |
| Example 10 | | | |

Referring to FIG. 7 and Table 3, the lithium secondary batteries of Examples 10 to 18 were found to have better lifetime characteristics than those of the lithium secondary batteries of Comparative Examples 6 to 10.

### Example 19

### Method of Synthesizing the Additive of Formula 1

To a mixture of R₂R₃NH or R₄R₅NH and triethylamine in dry dichloromethane, a solution of R₁—OPCl₂ in dry dichloromethane was added dropwise over 1 hr at −25˜-20° C. The formation of a white precipitate of triethylammonium hydrochloride was observed during the process. Then the reaction mixture was stirred at room temperature for an additional 1 hr, and hexane was added. The reaction mixture was allowed to stay overnight. Triethylammonium hydrochloride was filtered off and washed with hexane. The solvent was removed under vacuum, the residue was fractionalized under vacuum to give the compound of Formula 1, as shown below in Reaction Scheme 3.

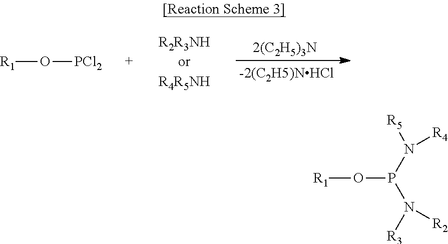

While the present invention has been shown and described with reference to certain embodiments thereof, it will be understood by those of ordinary skill in the art that various changes in form and details may be made therein without departing from the spirit and scope of the present invention. Further, it is to be understood that the invention is not limited to the disclosed embodiments, but, on the contrary, is intended to cover various modifications and equivalent arrangements included within the spirit and scope of the appended claims, and equivalents thereof.

Reference numerals in the drawings:

| | |
|---|---|
| 20: positive electrode current collector | 22: positive active material layer |
| 24, 28: thin film | 26: electrolyte |
| 30: negative active material layer | 32: negative electrode current |
| 34: lithium ions | collector |
| 38: negative electrode | 36: positive electrode |
| 112: negative electrode | 100: lithium secondary battery |
| 114: positive electrode | 113: separator |
| 140: sealing member | 120: battery case |

What is claimed is:

1. A phosphorus compound represented by the following Formula 1: 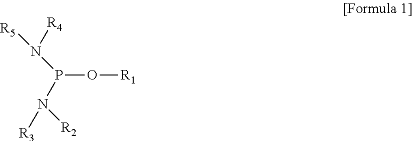
wherein:
R₁ to R₅ are each independently selected from a hydrogen atom, a halogen atom, a hydroxy group, a cyano group, —OR (where R is a C1-C10 alkyl group or a C6-C20 aryl group), —C(═O)Rₐ, —C(═O)ORₐ, —OCO(ORₐ), —(X)ₙ—NH₂ (where X is a C1-C10 alkyl group or a C1-C10 alkoxy group, and n is an integer from 0 to 10), —(X₁)ₙ—C(Rₐ)₃(where X₁ is a C1-C10 alkyl group or a C1-C10 alkoxy group, and n is an integer from 0 to 10), —(X₂)ₙ—CH═CH₂ (where X₂ is a C1-C10 alkyl group or a C1-C10 alkoxy group, and n is an integer from 1 to 10), —C═N(Rₐ), —SRₐ, —S(═O)Rₐ, —S(═O)₂Rₐ, a substituted or unsubstituted C1-C20 alkyl group, a substituted or unsubstituted C1-C20 alkoxy group, a substituted or unsubstituted C2-C20 alkenyl group, a substituted or unsubstituted C2-C20 alkynyl group, a C2-C20 alkylene oxide group, a substituted or unsubstituted C3-C30 cycloalkyl group, a substituted or unsubstituted C6-C30 aryl group, a substituted or unsubstituted C6-C30 aryloxy group, and a substituted or unsubstituted C6-C30 heteroaryl group, where Rₐ is selected from a hydrogen atom, a halogen atom, a C1-C10 alkyl group, and a C6-C20 aryl group.

2. The phosphorus compound according to claim 1, wherein R₁ is selected from a halogen atom,
—(X₁)ₙ—C(Rₐ)₃ (where X₁ is a C1-C10 alkyl group or a C1-C10 alkoxy group, and n is an integer from 1 to 10), and a substituted or unsubstituted C1-C20 alkyl group, where Rₐ is selected from a hydrogen atom, a halogen atom, a C1-C10 alkyl group and a C6-C20 aryl group.

3. The phosphorus compound according to claim 1, wherein R₁ is selected from —F, —Cl, —Br, —I, —(CH₂)—CF₃, —(CH₂)—CCl₃, —(CH₂)—CBr₃, —(CH₂)—CCl₃, —(CH₂)₂—CF₃, —(CH₂)₂—CCl₃, —(CH₂)₂—CBr₃, —(CH₂)₃—CF₃, —(CH₂)₃—CCl₃, —(CH₂)₃—CBr₃, —(CH₂)₄—CF₃, —(CH₂)₄—CCl₃, —(CH₂)₄—CBr₃, —(CH₂)₅—CF₃, —(CH₂)₅—CCl₃, —(CH₂)₅—CBr₃, —(CF₂)—CF₃, —(CF₂)₂—CF₃, —(CF₂)₃—CF₃, —(CF₂)₄—CF₃, —(CF₂)₅—CF₃, —(CF₂)—CCl₃, —(CF₂)₂—CCl₃, —(CF₂)₃—CCl₃, —(CF₂)₄—CCl₃, —(CF₂)₅—CCl₃, —(CCl₂)—CF₃, —(CCl₂)₂—CF₃, —(CCl₂)₃—CF₃, —(CCl₂)₄—CF₃, —(CCl₂)₅—CF₃, —(CCl₂)—CCl₃, —(CCl₂)₂—CCl₃, —(CCl₂)₃—CCl₃, —(CCl₂)₄—CCl₃, and —(CCl₂)₅—CCl₃.

4. The phosphorus compound according to claim 1, wherein R₁ is selected from —F, —(CH₂)—CF₃, —(CH₂)₂—CF₃, —(CH₂)₃—CF₃, —(CH₂)₄—CF₃, —(CH₂)₅—CF₃, —(CF₂)—CF₃, —(CF₂)₂—CF₃, —(CF₂)₃—CF₃, —(CF₂)₄—CF₃, and —(CF₂)₅—CF₃.

5. The phosphorus compound according to claim 1, wherein R₂ to R₅ are each independently selected from —(X₂)ₙCH═CH₂, (wherein X₂ is a C1-C10 alkyl group or a C1-C10 alkoxy group, and n is an integer from 1 to 10), —C═N(Rₐ), —S(═O)Rₐ, —S(═O)₂Rₐ, a substituted or unsubstituted C2-C20 alkenyl group, a substituted or unsubstituted C2-C20 alkynyl group, a C2-C20 alkylene oxide group, a substituted or unsubstituted C6-C30 aryl group, a substituted or unsubstituted C6-C30 aryloxy group, and a substituted or unsubstituted C6-C30 heteroaryl group, where Rₐ is selected from a hydrogen atom, a halogen atom, a C1-C10 alkyl group, and a C6-C20 aryl group.

6. The phosphorus compound according to claim 1, wherein R₂, to R₅ are each independently selected from a substituted or unsubstituted C2-C20 alkenyl group; and —(X₂)ₙ—CH═CH₂, wherein X₂ is a C1-C10 alkyl group or a C1-C10 alkoxy group, and n is an integer from 1 to 10).

7. The phosphorus compound according to claim 1, wherein R₂ to R₅ are each independently selected from —CH═CH₂, —(CH₂)—CH═CH₂, —(CH₂)₂—CH═CH₂, —(CH₂)₃—CH═CH₂, —(CH₂)₄—CH═CH₂, —(CH₂)₅—CH═CH₂, —(C₂H₄)₃—CH═CH₂, —(C₂H₄)₄—CH═CH₂, —(C₂H₄)₅—CH═CH₂, —(C₃H₆)₃—CH═CH₂, —(C₃H₆)₄—CH═CH₂, —(C₃H₆)₅—CH═CH₂, (CH₂O)—CH═CH₂, —(CH₂O)₂—CH═CH₂, —(CH₂O)₃—CH═CH₂, —(CH₂O)₄—CH═CH₂, —(CH₂O)₅—CH═CH₂, —(C₂H₄O)—CH═CH₂, —(C₂H₄O)₂—CH═CH₂, —(C₂H₄O)₃—CH═CH₂, —(C₂H₄O)₄—CH═CH₂, —(C₂H₄O)₅—CH═CH₂, —(C₃H₆O)—CH═CH₂, —(C₃H₈O)₂—CH═CH₂, (C₃H₆O)₃—CH═CH₂, —(C₃H₆O)₄—CH═CH₂, —(C₃H₆O)₅—CH═CH₂═C₄H₈O)—CH═CH₂, —(C₄H₈O)₂—CH═CH₂, —(C₄H₈O)₃—CH═CH₂, —(C₄H₈O)₄—CH═CH₂, —(C₄H₈O)₅—CH═CH₂, —(C₅H₁₀O)—CH═CH₂, —(C₅H₁₀O)₂—CH═CH₂, —(C₅H₁₀O)₃—CH═CH₂, —(C₅H₁₀O)₄—CH═CH₂, —(C₅H₁₀O)₅—CH═CH₂, and a substituted C2-C20 alkenyl group.

8. The phosphorus compound according to claim 1, wherein the phosphorus compound is represented by one of the following Formulas 2 to 6:

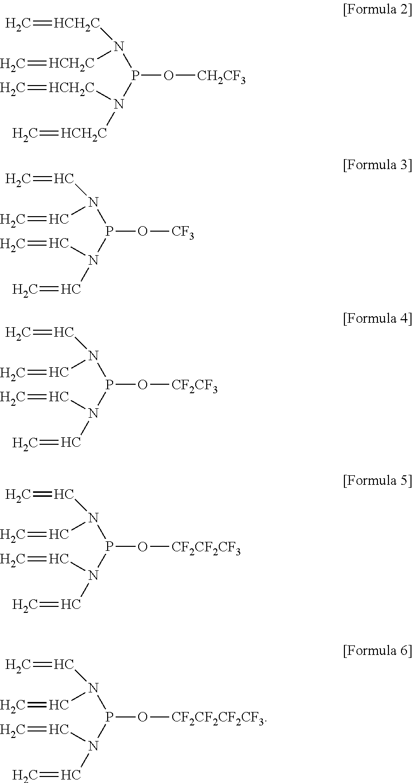

9. An electrolyte for a lithium secondary battery, the electrolyte comprising the phosphorus compound according to claim 1.

10. The electrolyte according to claim 9, wherein the phosphorus compound is present in an amount of about 0.3 wt % to about 13 wt % based on a total weight of the electrolyte.

11. The electrolyte according to claim 9, wherein the phosphorus compound is present in an amount of about 0.5 wt % to about 10 wt % based on a total weight of the electrolyte.

12. The electrolyte according to claim 9, further comprising a lithium salt and a non-aqueous organic solvent.

13. The electrolyte according to claim 12, wherein the lithium salt is selected from LiPF₆, LiBF₄, LISbF₆, LiAsF₆, LiCF₃SO₃, Li(CF₃SO₂)₃C, Li(CF₃SO₂)₂N, LiC₄F₉SO₃, LiClO₄, LiAlO₄, LiAlCl₄, LiBPh₄, LiN(CₓF₂ₓ₊₁SO₂)(CₓF_{2y+1}SO₂) (where x and y are non-zero natural numbers), LiCl, Lil, LIBOB (lithium bisoxalato borate), and combinations thereof.

14. The electrolyte of claim 12, wherein the nonaqueous organic solvent is selected from a carbonate-based solvent, an ester-based solvent, an ether-based solvent, a ketone-based solvent, an alcohol-based solvent, an aprotic solvent, and combinations thereof.

15. A method of preparing the phosphorus compound according to claim 1, the method comprising:
reacting a compound represented by the following Formula 12:
R₁—O—PX′₂ [Formula 12]
with a compound represented by the following Formula 13 or Formula 14:
R₂R₃NH [Chemical Formula 13]
or R₄R₅NH, [Chemical Formula 14]
wherein X′ is selected from chlorine, bromine and iodine.

16. A lithium secondary battery comprising an electrolyte, the electrolyte comprising an additive, the additive being a phosphorus compound represented by the following Formula 1: 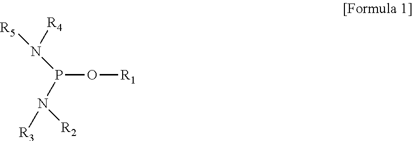
wherein:
R₁ to R₅ are each independently selected from a hydrogen atom, a halogen atom, a hydroxy group, a cyano group, —OR (where R is a C1-C10 alkyl group or a C6-C20 aryl group), —C(═O)Rₐ, —C(═O)ORₐ, —OCO(ORₐ), —(X)ₙ—NH₂ (where X is a C1-C10 alkyl group or a C1-C10 alkoxy group, and n is an integer from 0 to 10), —(X₁)ₙ—C(Rₐ)₃ (where X₁ is a C1-C10 alkyl group or a C1-C10 alkoxy group, and n is an integer from 0 to 10), —(X₂)ₙ—CH═CH₂ (where X₂ is a C1-C10 alkyl group or a C1-C10 alkoxy group, and n is an integer from 1 to 10), —C═N(Rₐ), —SRₐ, —S(═O)Rₐ, —S(═O)₂Rₐ, a substituted or unsubstituted C1-C20 alkyl group, a substituted or unsubstituted C1-C20 alkoxy group, a substituted or unsubstituted C2-C20 alkenyl group, a substituted or unsubstituted C2-C20 alkynyl group, a C2-C20 alkylene oxide group, a substituted or unsubstituted C3-C30 cycloalkyl group, a substituted or unsubstituted C6-C30 aryl group, a substituted or unsubstituted C6-C30 aryloxy group, and a substituted or unsubstituted C6-C30 heteroaryl group, where Rₐ is selected from a hydrogen atom, a halogen atom, a C1-C10 alkyl group, and a C6-C20 aryl group.

17. The lithium secondary battery according to claim 16, wherein the lithium secondary battery comprises:
a positive electrode comprising a positive active material configured to allow intercalation and deintercalation of lithium ions;
a negative electrode comprising a negative active material configured to allow intercalation and deintercalation of lithium ions; and
the electrolyte between the positive electrode and the negative electrode, the electrolyte comprising a lithium salt, and a nonaqueous organic solvent.

18. The lithium secondary battery according to claim 16, further comprising a thin film on a surface of the positive electrode, the thin film comprising the additive.

19. The lithium secondary battery according to claim 16, further comprising a solid electrolyte interface SEI) layer on a surface of the negative electrode, the solid electrolyte interface (SEI) layer comprising a reaction product of the additive.

20. The lithium secondary battery according to claim 16, wherein the positive active material has an operation voltage of about 4.0V to about 5.5V.
